(19) United States
(12) Patent Application Publication
(10) Pub. No.: US 2013/0135223 A1
(43) Pub. Date: May 30, 2013

(54) FINGER-WORN INPUT DEVICES AND METHODS OF USE

(71) Applicant: Saar Shai, Kochav Yair (IL)

(72) Inventor: Saar Shai, Kochav Yair (IL)

(73) Assignee: RINGBOW LTD., Kochav Yair (IL)

(21) Appl. No.: 13/515,294

(22) PCT Filed: Dec. 13, 2010
(86) PCT No.: PCT/IB10/55776

§ 371 Date: Jun. 12, 2012

Related U.S. Application Data
(60) Provisional application No. 61/286,007, filed on Dec. 13, 2009.

(51) Int. Cl. G06F 3/033

(52) U.S. Cl. CPC G06F 3/033
USPC 345/173; 345/156

(57) ABSTRACT

Disclosed are devices for wearing on fingers, and similar devices held by fingers, and systems which include said devices, some of which include various sensing means for facilitating different types of interactions, or for registering input which may be utilized by interfaces, such as for performing certain functions and providing certain features. Further provided are methods of interaction which utilize said devices, and related interfaces.

### FIELD OF THE INVENTION

The invention relates in general to human-computer interaction (HCI) and in particular to input devices and user interfaces (UIs).

### BACKGROUND OF THE INVENTION

There are known in the art finger-worn devices (or “ring devices”) for a variety of functions or uses. Several are known as substituting a computer mouse or a so-called “trackball”, for navigating graphic user interfaces (GUIs). However, such devices include unnecessary elements and features which render them bulky and uncomfortable to use, whereas some of said features find better alternatives in other technologies such as touch-screens and visual-recognition which, as the invention suggests, may be adapted to be used (or “interacted with”) in collaboration with operating finger-worn devices, some of which are provided by some embodiments of the invention.

Further known in the art are mechanisms, techniques and methods for sensing vibrations. Whereas some are known to be utilized for user interfaces (UIs) and other human-machine interaction (HMI) purposes, none have been mentioned to be integrated in a finger-worn device, for providing input for interfaces, as suggested here for some embodiments of the invention. Additionally, none have been mentioned to be utilized for a direct alternative to touch-screens while still providing users with similar functionality and features, as described here for some embodiments of the invention.

The rapid development of small electronic, optical and mechanical components (as known for “miniaturization”, e.g. MEMS), sensors and sensing methods, and smart materials facilitate incorporating tiny components in finger-worn devices, while being able to achieve an appropriate size of such devices, to allow for market viability (such as pertaining to manufacturing costs) and desirability (such as pertaining to usability). As wearable devices find a growing demand in the market, new solutions for integrating different technologies are needed, along with new methods for interaction.

### SUMMARY OF THE INVENTION

The invention provides, in various embodiments, devices which can be worn on a finger (or otherwise “finger-worn devices”). There are provided such devices which may be utilized as input device, such as to facilitate certain types of interactions by being operated. Further provided are methods of operating (or “using”) such devices. Further provided are methods of interaction which utilize such finger-worn devices.

An object of the invention is to provide finger-worn devices which facilitate interactions similar to those performed with touch-screens and other touch sensing mechanisms, yet without the requirement of touch sensing means as known for touch-screens and for other touch sensing mechanisms. In other words, some embodiments of the invention provide alternatives to touch-screen devices, systems or apparatuses, and similar mechanisms for sensing touch, while still providing similar functionality and features. Said alternatives may utilize finger-worn devices.

Another object of the invention is to provide means and methods for enhancing the interactivity of, or in other words addition features to, devices which include touch-screens or other touch sensing mechanisms. For example, some embodiments of the invention incorporate input related to poses of a finger interacting with a touch-screen.

Other objects of the invention are to provide finger-worn devices, and mechanisms thereof, and related methods, for detecting bending of fingers and/or pressure applied by fingers.

Another object of the invention is to provide finger-worn devices and fingers-held devices which can be used similarly to playing musical instruments, and/or which add functionalities to playing musical instruments.

Another object of the invention is to provide tactile feedback for fingers interacting with touch-screens and other touch sensing mechanisms, such as by incorporating magnetic fields.

### BRIEF DESCRIPTION OF THE DRAWING

FIG. 1A is a perspective view of a device of the invention;

FIG. 1B is a cross-section view of a device of the invention worn on a finger;

FIG. 1C is a perspective view of a device of the invention;

FIGS. 1D and 1E are cross-section views of a device of the invention worn on a finger;

FIGS. 2A through 2D are perspective views of a device of the invention;

FIG. 2E is a perspective view of a device of the invention;

FIGS. 2F through 2J are side views of a device of the invention worn on a finger and representations of an interface;

FIG. 3A is a perspective view of a device of the invention;

FIG. 3B is a side view of a system of the invention;

FIG. 3C is a cross-section view of a device of the invention;

FIG. 3D is a perspective view of a device of the invention;

FIG. 3E is a perspective view of a device of the invention worn on a finger;

FIG. 3F is a perspective view of a device of the invention worn on a thumb;

FIG. 3G is a perspective view of a system of the invention;

FIG. 4A is a perspective view of a device of the invention;

FIG. 4B is a cross-section view of a device of the invention worn on a finger;

FIGS. 4C and 4D are side views of a system of the invention;

FIGS. 4E and 4F are top views of a system of the invention;

FIG. 5 is a flowchart of a method of the invention;

FIG. 6A is a cross-section view of a device of the invention;

FIG. 6B is a cross-section view of a device of the invention worn on a finger;

FIG. 6C is a cross-section view of a system of the invention;

FIGS. 6D and 6E are cross-section views of a device of the invention worn on a finger;

FIG. 6F is a perspective view of a system of the invention;

FIG. 7A is a perspective view of a device of the invention;

FIG. 7B is a side view of a system of the invention;

FIG. 7C is a cross-section view of a system of the invention;

FIG. 7D is a cross-section view of a device of the invention;

FIG. 8A is a perspective view of a system of the invention;

FIG. 8B is a perspective view of a system of the invention;

FIG. 9A is a perspective view of a system of the invention;

FIG. 9B is a perspective view of a system of the invention;

FIG. 9C is a perspective view of a system of the invention;

FIG. 9D is a perspective view of a system of the invention;

FIG. 10A is a perspective view of a system of the invention;

FIG. 10B is a perspective view of a system of the invention;

FIG. 10C is a top view of a device of the invention;

FIG. 10D is a perspective view of a device of the invention held by fingers;

FIG. 11A is a perspective view of a device of the invention;

FIGS. 11B through 11F are perspective views of a device of the invention worn on a finger;

FIG. 11G is a perspective view of a system of the invention;

FIG. 12A is a perspective view of a system of the invention;

FIG. 12B is a perspective view of a system of the invention;

FIG. 12C is a perspective view of a system of the invention;

### DETAILED DESCRIPTION OF THE INVENTION

Note that each of a hand 110 and a hand 110′ may be shown in different figures as a left hand or a right hand, for depiction purposes only. It is made clear that the described herein may apply to any hand and is not limited by handedness.

Further note that dashed, and dashed-dotted, lines and arrows, in certain figures, may have different purposes of depiction, or different illustrative functions. For example, some elements may be illustrated by dashed lines to distinguish them from other elements, whereas other elements may be illustrated by dashed lines for depicting they are background elements which are supposedly obscured by elements in the foreground, or internal elements positioned inside a device.

Further note that it is understood that for some of the described herein, the terms detecting and ascertaining may be used interchangeably.

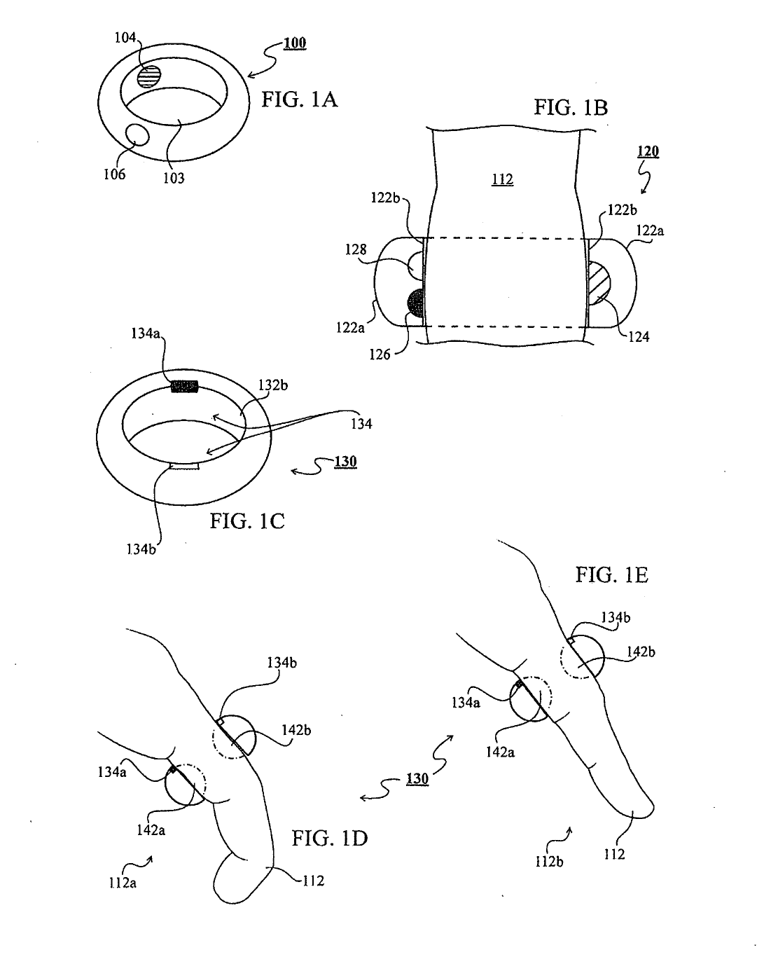

Referring now to the invention in more detail, FIG. 1A shows an embodiment of the invention as a finger-worn device 100 (or simply “device”) which can be worn on a finger, such as by including a cavity 103 through which a finger may be inserted.

In FIG. 1A, device 100 is shown including a finger bending detection mechanism 104 (or simply “mechanism”) which can detect, or facilitates detecting, bending of a finger on which the device is worn, by any means known in the art (see e.g. U.S. Pat. No. 6,861,945). Note that mechanism 104 may include and/or utilize any of optical sensing mechanism 124 (see ref. FIG. 1B), mechanical activity detection mechanism 128 (see ref. FIG. 1B) and tension detection mechanism 134 (see ref. FIG. 1C).

Device 100 may further include a control mechanism 106 which can be manipulated (or operated) by a user for registering input, and/or for inducing operations, preferably input and/or operations which correspond to how (or in other words in what manner) the control mechanism is manipulated. For example, the control mechanism may include any of buttons, sensors (e.g. touch sensors, motion sensors, proximity sensors and the like), switches, keys, knobs, scroll-wheels, joysticks, sliders and the like. Note that for the described herein, corresponding input and corresponding operations may refer to input and operations which are based on, and/or derived from, and/or in any way characterized by, and/or proportional to, anything to which said input and operations are corresponding to, such as actions (e.g. manipulation, motion, sensing), information (e.g. detections), occurrences (e.g. vibrations), properties (e.g. pressure, direction), elements (e.g. interface elements, mechanisms), items (e.g. devices) and so on.

Note that any number of elements of control mechanism. 106 may be coupled or connected to any number of sections of device 100 and may be manipulated for similar results. Accordingly, in the described herein, referring to manipulating control mechanism 106, and similarly to any control mechanism of any device, may also relate to manipulating any number of sections of a device (which includes the control mechanism) to which any number of elements of the control mechanism is connected and/or coupled. For example, control mechanism 106 may be coupled to a rotatable outer section of device 100 so that said rotatable outer section may be rotated by a user for registering input.

Following the above, input which is based on, or corresponds to, bending of a finger on which device 100 is worn, by any number of operations of mechanism 104 (e.g. sensing of said finger), may be registered. Additional input may be registered which is based on, or corresponds to, manipulating control mechanism 106. Note that any of the described herein for registering input may also refer to inducing any number of operations, such as operations which correspond to registered input.

Referring now to FIG. 1B, there is shown an embodiment of the invention as a finger-worn device 120 (or simply “device”) which can be worn on a finger, as shown in the figure worn on a finger 112. Operations of device 120, or specifically of any number of elements thereof, may facilitate detecting bending of finger 112 by directly sensing the section of the finger on which the device is worn, as opposed to prior art wherein detecting bending of a finger is achieved by sensing other sections of said finger (see e.g. U.S. Pat. No. 6,861,945), such as a joint (see e.g. U.S. Pat. No. 5,097,252), or by a device sensing changes thereto caused by bending of said finger (see e.g. U.S. Pat. No. 5,097,252). For example, as opposed to what is known in the art, device 120 may be worn (directly, or only) on the proximal phalanx section of finger 112, whereas detecting bending of the finger may be facilitated by sensing only the proximal phalanx section of the finger.

In some embodiments, device 120 may include an optical sensing mechanism 124 which can optically sense the section of finger 112 on which the device is worn, for facilitating detecting bending of the finger. Optionally, optical sensing mechanism 124 can optically sense the skin, or specifically features thereof, of the section of finger 112 on which the device is worn. Additionally or alternatively, optical sensing mechanism 124 can sense inner elements of the section of finger 112 on which the device is worn, such as tendons and/or blood vessels and/or flesh, and optionally can sense changes in said inner elements.

As finger 112 bends, changes occur in certain features of the skin of the finger, specifically in the proximal and intermediate phalanges of the finger, on any of which device 120 may be worn. For example, it is known that the skin of proximal and intermediate phalanges of fingers include patterns of ridges (or “friction ridges”) similar to fingerprints. Bending a finger may cause changes in said patterns, as the skin is relaxed or stretched. Detecting bending of finger 112 may be facilitated by optically sensing patterns of ridges in the section of the finger on which device 120 is worn, or specifically changes in said patterns, such as by optical sensing mechanism 124.

In some embodiments, device 120 may include a light source 126 to which optical sensing mechanism 124 may be coupled, or which the optical sensing mechanism can utilize, and which can illuminate the skin and/or inner elements of the section of finger 112 on which the device is worn, for facilitating optical sensing by the optical sensing mechanism.

Note that in some embodiments of a finger-worn device of the invention which includes mechanism 124, sensing may be performed without direct contact of any section of said finger-worn device from which sensing is performed (e.g. where photodiodes may be located) with the skin of the section on which said finger-worn device is worn.

Note that in some embodiments, alternatively to including optical sensing mechanism 124, and similarly to the described for sensing patterns of ridges in the skin of finger 112, device 120 may include any fingerprint sensing mechanisms known in the art (see e.g. U.S. Pat. No. 7,738,681), for sensing changes in “friction ridges” in the skin of the section of finger 112 on which the device is worn, said sensing facilitating detection of bending of the finger.

In some embodiments, alternatively to including optical sensing mechanism 124, device 120 may include mechanical activity detection mechanism 128 (or simply “mechanism”) which can detect, or facilitate detecting, mechanical activity in (or of) the section of finger 112 on which device 120 is worn, for facilitating detecting bending of the finger.

In some embodiments, detecting mechanical activity in the section of finger 112 on which device 120 is worn, by mechanism 128, may be facilitated by sensing vibrations, or any acoustic activity, generated in the section by bending of the finger, such as known in the art for sensing vibrations from biological activity, or specifically as known for phonomyography, vibromyography and mechanomyography. For example, mechanism 128 may detect the force of contraction of tendons and/or muscles by recording the low frequency sounds created during muscular activity, such as by including any number of microphones (e.g. condenser microphones) and/or any number of accelerometers, and/or any number of other sensors known in the art for sensing vibrations.

Referring now to PG. 1C, there is shown a finger-worn device 130 (or simply “device”) which can be worn on a finger and which includes a tension detection mechanism 134 (or simply “mechanism”) which can detect, or facilitate detecting, tension in the section of a finger on which device 130 is worn, or specifically in any element of the flesh of said the section, by any means known in the art (see e.g. U.S. patent application Ser. No. 11/929,514). Detecting tension may be facilitated by sensing the skin of the section of said finger on which the finger-worn device is worn, specifically the skin with which the finger-worn device, or any element thereof, comes in direct contact. Note that said tension may refer to stretching and relaxing of certain areas of the skin.

In some embodiments, finger-worn device 130 may have a body 132 which has an inner section 132b. The inner section may be any section that comes in contact with a finger which is wearing device 130, specifically with the skin of the section of said finger on which the finger-worn device is worn. Optionally, mechanism 134, or any element thereof, may be located at (or on) inner section 132b, for providing access to the skin of said finger. In FIG. 1C there are shown sensors 134a,b, which may be included in mechanism 134 and which are positioned so that when device 130 is worn on a finger the sensors can sense tension in the skin of said finger, specifically at the section of said finger where the device is worn, and optionally by coming in contact with the skin of the section.

It is known that the human skin is flexible. It is also known that when a finger is straight and when a finger is bent, different areas of the skin of said finger may have (or may be affected by) different amounts of tension. In other words, when a finger is bent, certain areas of the skin of said finger are stretches, whereas other areas of the skin are relaxed, relative to when said finger is straight. Accordingly, changes in tension in different areas of the skin of a finger may be detected for ascertaining bending of a finger.

Note that in some embodiments, tension may be detected optically, optionally without contact with the skin, as known in the art (see e.g. U.S. Pat. No. 6,324,419).

Referring now to FIGS. 1D and 1E, there is shown finger-worn device 130 worn on finger 112, specifically on the proximal phalanx section of the finger. Further specifically, the device is positioned such that sensors 134a,b of mechanism 134 come in contact with the skin of the proximal phalanx section. Even more specifically, there is shown sensor 134a coming in contact with an area 142a of the skin of the proximal phalanx section, and sensor 134b coming in contact with an area 142b of the skin of the proximal phalanx section. Notice areas 142a,b marked by a dashed-dotted half circles in the figures. Note that as shown in the figure, by way of example, area 142a may be a palmar area of the skin, whereas areas 142b may be a dorsal area of the skin. Further note areas 142a,b may be at opposite sides of the proximal phalanx section.

In FIG. 1D, finger 112 is shown being in a pose 112a wherein the finger may be bent to a certain extent. Consequently, area 142a may be relaxed to a certain degree, such as relatively to when finger 112 is straight, whereas area 142b may be stretched to a certain degree, such as relatively to when finger 112 is straight. Accordingly and following the above, sensor 134a may sense (e.g. measure) the stretching of area 142b and the relaxing of area 142a for ascertaining that finger 112 is bent.

In FIG. 1E, finger 112 is shown being in a pose 112b wherein the finger may be straight to a certain extent. Consequently, area 142a may be stretched to a certain degree, such as relatively to when finger 112 is straight, whereas area 142b may be relaxed to a certain degree, such as relatively to when finger 112 is straight. Accordingly and following the above, sensor 134a may sense the relaxing of area 142b and the stretching of area 142a for ascertaining that finger 11.2 is straight.

Note that by sensing the skin (or specifically different areas thereof) of the section of a finger on which device 130 is worn, such as by sensing relaxing and stretching of areas 142a,b of the skin of the proximal phalanx section of finger 112, ascertaining whether said finger is bent or straight may be facilitated. Further facilitated by the sensing may be ascertaining to what extent or degree said finger is bent or straight.

Further note that following the above, mechanism 134 may facilitate detecting bending of a finger on which a device of the invention is worn, such as by being included in finger bending detection mechanism 104 (see ref. FIG. 1A), in some embodiments.

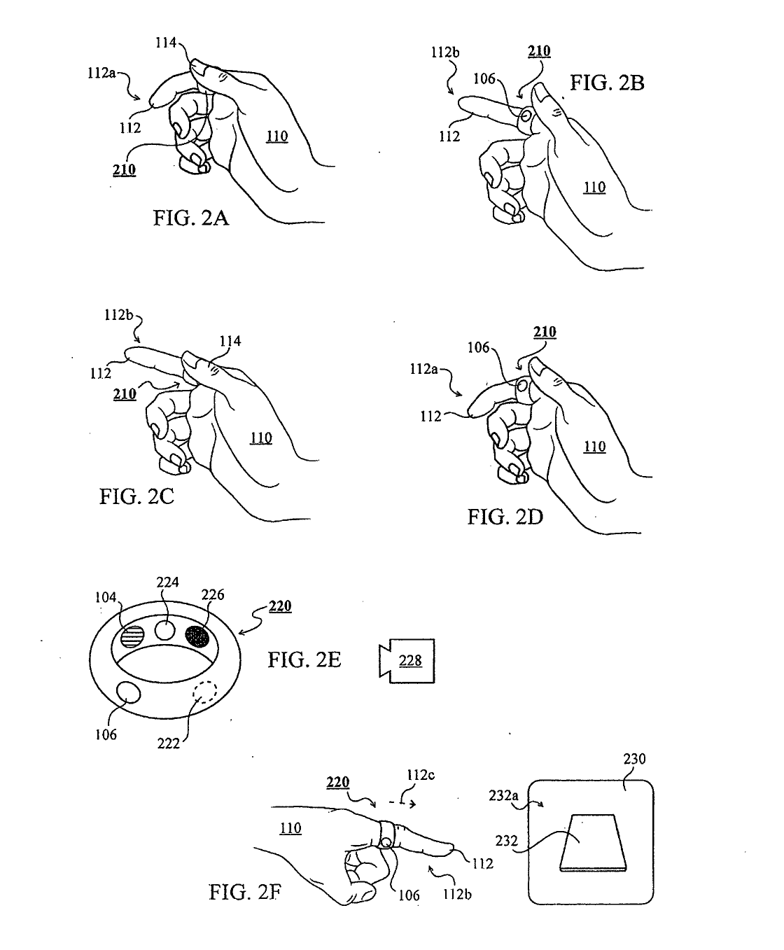

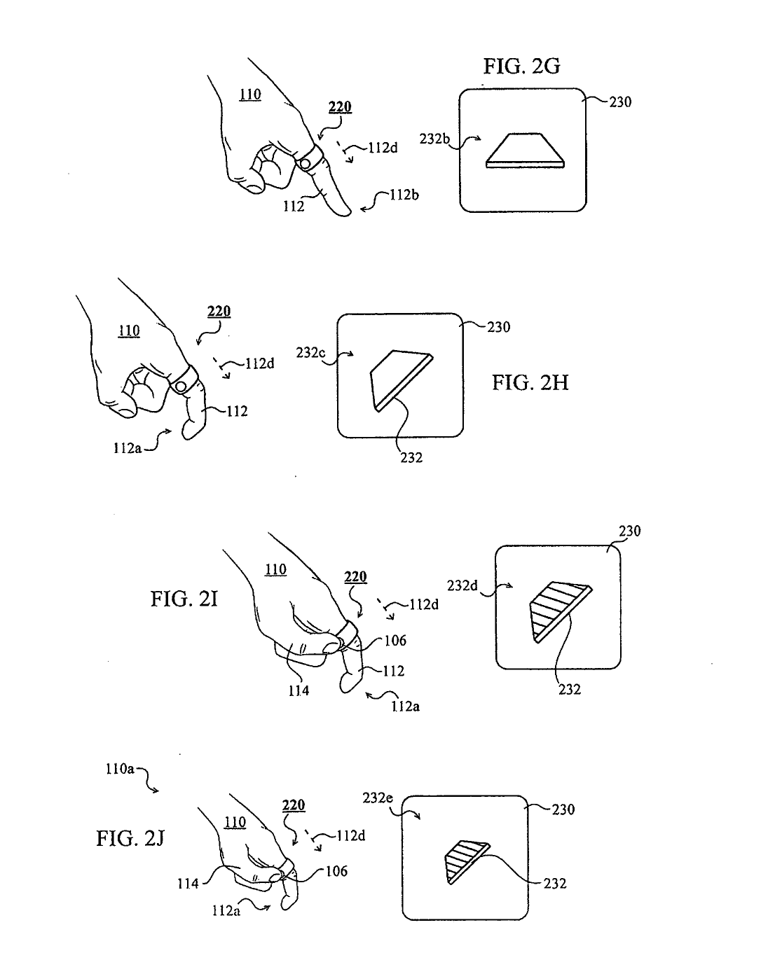

Referring now to FIGS. 2A through 2D, there is shown an embodiment of the invention as a finger-worn device 210 (or simply “device”) which may be similar to any of the finger-worn devices described for FIGS. 1A through 1E. Accordingly, device 210 may detect, or facilitate detecting, bending of a finger on which the device is worn (shown in FIGS. 2A through 2D worn on finger 112 of hand 110), by including any of the mechanisms described for finger-worn devices in FIGS. 1A through 1E. For example, device 210 may include finger bending detection mechanism 104 (see ref. FIG. 1A).

Device 210 may further include control mechanism 106 (see ref. FIG. 1A) which can be manipulated by a thumb 114 of hand 110. Accordingly and following the above, a first type of input, which is based on, or corresponds to, bending of finger 112, may be registered, in addition to a second type of input which is based on, or corresponds to, manipulation of control mechanism 1.06. Optionally, different combinations of inputs of said first and second types may induce different operations, such as of device 210 and/or of any device with which device 210 communications.

In FIG. 2A, finger 112 is specifically shown being in pose 112a, whereas thumb 114 of hand 110 is shown manipulating control mechanism 106 of device 210. By detecting pose 112a of the finger, such as by a finger bending detection mechanism of device 210, and by manipulating (or detecting manipulations) of the control mechanism by the thumb, a first combination of inputs may be registered. Said first combination may induce a first operation. Similarly, in FIG. 2B there is specifically shown finger 112 being in pose 112b and control mechanism 106 not manipulated, so that a second combination of inputs may be registered, such as by detecting pose 112b and registering a corresponding input, and by registering an additional input which corresponds to the control mechanism not being manipulated. Said second combination may induce a second operation. Further similarly, in FIGS. 2C and 2D, finger 112 is shown being in poses 112b and 112a, respectively, whereas control mechanism 106 is shown manipulated and not manipulated, respectively, so that a third and fourth combinations of inputs may be registered, respectively, optionally for inducing a third and fourth operation, respectively.

For example, when finger 112 is in pose 112a while control mechanism 106 is manipulated, a combination of inputs, based on the pose and manipulation, may be registered at any electronic device receiving communications from device 210, and may be computed by said electronic device for executing a first operation of said electronic device, such as a first reaction of an interface of said electronic device. Similarly, when the finger is in pose 112b while the control mechanism is manipulated, a different combination of inputs may be registered at said electronic device, for executing a different operation, such as a different reaction of said interface. Other combinations may be registered when the finger is in poses 112a,b while the control mechanism is not manipulated, for executing other operations of said electronic device.

Note that whereas in FIGS. 2B and 2C control mechanism 106 of device 210 is not manipulated, the described may refer to the control mechanism being manipulated in a different manner than the described for FIGS. 2A and 2D. For example, the described for FIGS. 2A and 2D may refer to an element of control mechanism 106 being pushed by thumb 114 towards a certain direction, as an exemplary manipulation of the control mechanism, whereas the described for FIGS. 2B and 2C may refer to said element being pushed towards a different direction (as opposed to the control mechanism not being manipulated).

Further note that additionally or alternatively to registering two input types based on poses of finger 112 and on manipulation (or lack thereof) of control mechanism 106, a single input may be registered for each combination of said two input types. For example, a different input may be registered for each of FIGS. 2A through 2D, corresponding to which pose finger 112 is in at each figure, and also corresponding to whether (and/or how) control mechanism 106 is manipulated in each figure.

The described above for FIGS. 2A through 20, may be beneficial for adding features to interactions involving bending of fingers.

Referring now to FIG. 2E, there is shown an embodiment of the invention as a finger-worn device 220 (or simply “device”) which can be worn on a finger. The finger-worn device may include any of control mechanism 106 (in accordance with the described above), finger bending detection mechanism 104 (in accordance with the described above), a location detection mechanism 222, an indication mechanism 224 and a direction detection mechanism 226.

Location detection mechanism 222 may detect, or facilitate detecting, the location of device 220, by any means known in the art (see e.g. U.S. Pat. No. 7,688,307). For example, location detection mechanism 222 may include an accelerometer for sensing motion along any of three axes, so that the relative distance traveled by device 220 may be ascertained and computed to deduce the location of the device along any of said three axes. Note that the location of the device at any given time corresponds to the location of a finger on which it is worn, specifically to the location of the section of said finger (e.g. the proximal phalanx section) on which the device is worn, and generally to the location of hand of said finger. Accordingly, by detecting the location of the device at any given time may facilitate ascertaining the location of said finger, said section of said finger, and/or said hand, to any degree of precision. For example, moving the device a certain distance in a certain direction requires moving the hand of a finger on which the device is worn said certain distance in said certain direction. Note that for some purposes of the described herein, the locations of any of a finger-worn device, the finger on which said finger-worn device is worn, the specific section (of the finger) on which said finger-worn device is worn, and the hand of the finger, may be regarded as generally the same.

Direction detection mechanism 226 may detect, of facilitate detecting, the direction of device 220, or in other words the angle or orientation at which the device is positioned, by any means known in the art (see e.g. U.S. Pat. Nos. 5,239,489, 6,466,198 and 7363147), such as by including a compass, an accelerometer and/or a gyroscope. For example, the tilt of the device relative to the ground may be measured by a gyroscope. For another example, the direction at which the device is positioned may be detected by utilizing a compass. Note that the direction of device 220 at any given time corresponds to the direction of the section of a finger on which the device is worn, and may correspond to the direction of a hand of said finger when said section is aligned with the palm of said hand.

Indication mechanism 224 may indicate, or facilitate indicating, the location and/or direction of device 220 to any remote device or mechanism, such as to an indication detection mechanism 228 (or simply “mechanism”), by any means known in the art (see e.g. U.S. Pat. Nos. 7,019,672, 5,239,489, 6,111,565 and 6,335,723). Accordingly, utilizing indication mechanism 224 and mechanism 228 may facilitate detecting the location and/or direction of the device. For example, indication mechanism 224 of device 220 may generate signals, or any other type of output (e.g. light) which can be sensed by any number of elements of mechanism 228 (e.g. an array of light receivers), for identifying certain properties of said signals (or of said other type of output) which may be indicative of the distance of the device from, and/or the orientation of the device relative to, any of said number of elements of mechanism 228. Note that mechanism 228 may be included in a device other than device 220.

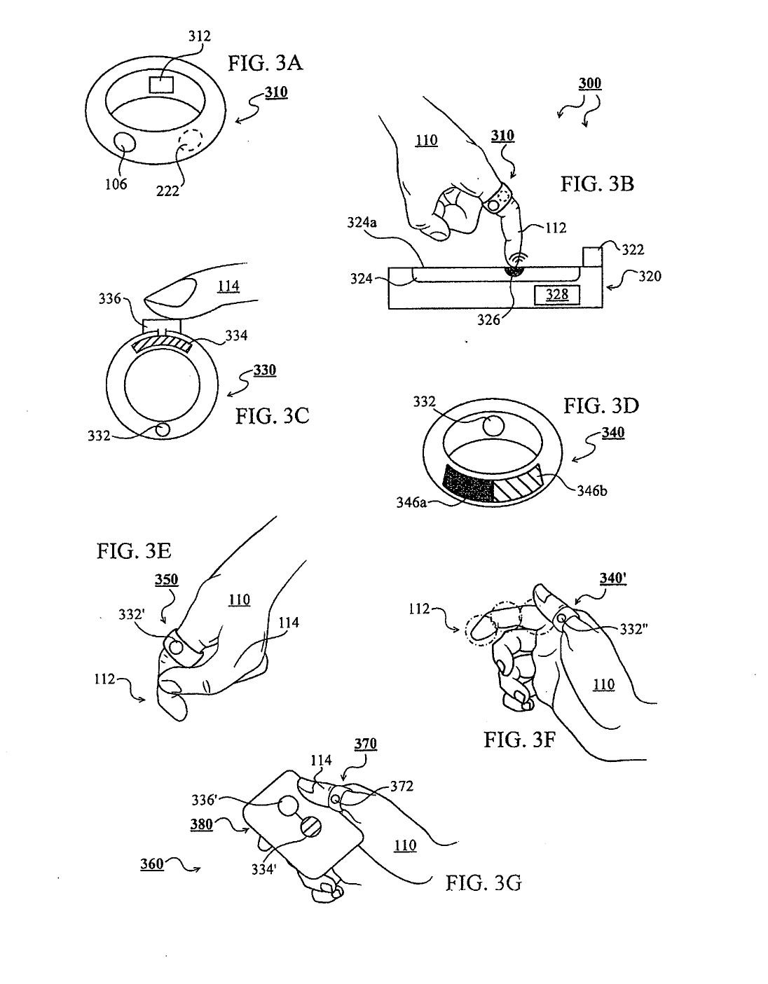

Following the above, note that the described herein for location detection mechanism 222 and/or for direction detection mechanism 226 may also refer to a combination of an indication mechanism and an indication detection mechanism, which may provide similar results (i.e. detection of location and/or direction). For example, in FIG. 3B (see below), in some embodiments of system 300, location detection mechanism 222 of finger-worn device 310 may be substituted by indication mechanism 224, whereas device 320 may include indication detection mechanism 228, for detecting the location of device 310, such as by identifying properties of indications generated by indication mechanism 224.

Referring now to FIGS. 2F through 2J, there is shown device 220 (see ref. FIG. 2E) worn on finger 112 of hand 110, and an interface 230 including an interface element 232. Interface 230 may be any interface of a program, such as a graphic user-interface of computer software. Interface element 232 may be any element of (or in) interface 230, such as a graphic object. The interface, or specifically the interface element, may be controlled or influenced by (and/or react to) the location of device 220, and/or the direction of device 220, and/or bending of finger 112 (on which the device is worn), and/or manipulations of control mechanism 106 of the device. For example, the location and direction of the device, as sensed by sensors of location detection mechanism 222 and direction detection mechanism 226 (in case the mechanisms include sensors), or as indicated by indication mechanism 224, may be registered as inputs, such as in a remote device receiving information from device 220 (specifically information related to the location and direction of device 220), or by a remote device which includes a mechanism 228 which detects indications from indication mechanism 224, so that said inputs may be utilized by interface 230, or by a program of a remote device, to control properties of interface element 232. Bending of finger 112 and manipulations of control mechanism 106 may similarly be registered as inputs, for controlling properties of the interface element.

In FIG. 2F, finger 112 is shown being in pose 112b (e.g. generally straight), whereas the section of the finger on which device 220 is worn (e.g. the proximal phalanx section of the finger) is shown positioned in a direction 112c. Additionally, control mechanism 106 is shown not manipulated. Following the above, interface element 232 may consequently (or correspondingly) be, as shown in the figure, in a position 232a. In FIG. 2G, finger 112 is shown being in pose 112b (similar to the shown in FIG. 2F), whereas the section of the finger on which the device is worn is shown positioned in a direction 112d (notice the section tilted downward from its direction in FIG. 2F). Additionally, control mechanism 106 is shown not manipulated. Consequently, interface element 232 is shown in FIG. 2G having a position 232b (notice the interface element tilted relative its position in FIG. 2F) which may correspond to pose 112b of finger 112, to direction 112d of the aforementioned section of the finger, to control mechanism 106 not being manipulated and to the location of finger-worn device 220. In FIG. 2H, finger 112 is shown being in pose 112a, the section of the finger on which device 220 is worn is shown positioned in direction 112d (similarly to the shown in FIG. 2G), and control mechanism 106 is shown not manipulated. Consequently, interface element 232 is shown in FIG. 2H having a position 232c (notice the interface element rotated relative to its position in FIG. 2G), such as in response to inputs registered based on pose 112a of finger 112, on direction 112d of the aforementioned section, on the location of device 220, and/or on control mechanism 106 not being manipulated (or otherwise based on detections of the pose, the direction, the location and/or the manipulation, or lack thereof). In FIG. 2I, finger 112 is shown being in pose 112a, whereas the section of the finger on which device 220 is worn is shown positioned in direction 112d. Additionally, control mechanism 106 is shown in FIG. 2I being manipulated by thumb 114 of hand 110 (as opposed to the shown in FIGS. 2F through 2H). Consequently to the control mechanism being manipulated, interface element 232 is shown in FIG. 2I having a state 232d which may correspond to the control mechanism being manipulated. Note that the position of the interface element in FIG. 2I may be similar to the position of the interface element in FIG. 2H, correspondingly to finger 112 being in pose 112a, and to the section of the finger on which device 220 is worn positioned in direction 112d, in both FIGS. 2H and 2I. In FIG. 2J, finger 112 is shown being in pose 112, the section of the finger on which device 220 is worn is shown positioned in direction 112d, and control mechanism 106 is shown manipulated by thumb 114 of hand 110. Additionally, hand 110 is shown being in a location 110a (notice the hand distanced away from the point of view of FIGS. 2F through 23, or in other words relative to its location in FIGS. 2F through 2I). Consequently to hand 110 being in location 110a, interface element 232 is shown in FIG. 2J being in a location 232e (notice the interface element distanced relative to its location in FIGS. 2F through 2I, from the point of view of FIGS. 2F through 2J). Note that hand 110 moving to location 110a causes device 220 to move correspondingly, so that by detecting hand 110 being in location 110a the location of the device may be ascertained. Further note that the position and state of the interface element in FIG. 23 may be similar to the position and state of the interface element in FIG. 2I, correspondingly to finger 112 being, in pose 112a, and to the section of the finger on which device 220 is worn positioned in direction 112d, and to control mechanism 106 being manipulated, in both FIGS. 2I and 2J.

Note that whereas in FIGS. 2F through 2H control mechanism 106 of device 220 is not manipulated, the described for the figures may refer to the control mechanism being manipulated in a different manner than the described for FIGS. 2I and 2J.

Further note that the described for position, location and state of interface element 232 in FIGS. 2F through 2J, may refer to any settings or properties of an interface and/or of any number of elements thereof. Said settings or properties may not necessarily be spatial or visual.

Further note that in some embodiments of the invention, any detections other than detections of any of the location of device 220, and/or the direction of device 220, and/or bending of finger 112 (on which the device is worn), and/or manipulations of control mechanism 106 of the device, may additionally control or influence interface element 232 and/or interface 230. Preferably, detections of touch of finger 112, such as known for touch-screens and touchpad, may control or influence interface element 232 and/or interface 230 in addition detections of any of the location of device 220, and/or the direction of device 220, and/or bending of finger 112 (on which the device is worn), and/or manipulations of control mechanism 106 of the device.

Referring now to FIG. 3A, there is shown an embodiment of the invention as a finger-worn device 310 (or simply “device”) which can be worn on a finger. Device 31.0 may include any of control mechanism 106, in accordance with the described above, location detection mechanism 222 (as described for device 220; see ref. FIG. 2E) and a vibrations detection mechanism 312. The vibrations detection mechanism may detect, or facilitate detecting, vibrations, or specifically acoustic reactions or phonic signals, in (or of, or through) a finger on which device 310 is worn, or specifically in any number of sections (e.g. the proximal phalanx section) thereof, and in any number of elements (e.g. bones and/or tendons) thereof, as known in the art (see e.g. U.S. Pat. No. 6,380,923). For example, vibrations detection mechanism 312 may include and/or utilize any number of microphones (e.g. condenser microphones, as known in the art), accelerometers, transducers and/or amplifying means, which can sense mechanical vibrations, such as similarly to “pickups” as known in music technology, specifically for stringed instruments.

In some embodiments, vibrations detection mechanism 312 can detect, or facilitate detecting, vibrations which are caused by (or in other words are reactions of) a finger wearing device 310, or specifically the tip of said finger, physically interacting with an object or surface. Specifically, the vibrations detection mechanism may detect (or facilitate detecting) vibrations caused by tapping on a surface or an object (e.g. a table). Said vibrations may propagate from the contact (or impact) location of said finger, or tip thereof, and said surface or object. Detection of said vibrations by vibrations detection mechanism 312 of device 310, which may be worn on a section of said finger which is not the tip, may be facilitated by said vibrations conducted by (or in, or through) the bones of said finger, from the tip of said finger to said section, such as known for so-called “bone-conduction” which is commonly utilized for earphones and hearing aids, for the conduction of sound through bone.

Following the above, a first input may be registered which corresponds (or is based on) manipulation of control mechanism 106, a second input may be registered which corresponds to the location of device 310, such as detected by location detection mechanism 222 of the device, and a third input may be registered which corresponds to vibrations, or any property thereof, detected by detection mechanism 312. Said third input may be utilized to identify tapping of a finger wearing device 310, or in other words to ascertain whether (or when) said finger is tapping.

In some embodiments, vibrations detection mechanism 312 can detect, or facilitate detecting, vibrations which are caused by a finger wearing device 310 (or the tip of said finger) detaching from a surface. Vibrations caused by detachment of said finger may be different from vibrations caused by tapping, such as different in certain properties (e.g. frequency, intensity, duration, sequence and the like). Accordingly, identifying properties of detected vibrations may facilitate ascertaining whether said finger is tapping on a surface or detaching from a surface.

Note that analyzing properties of vibrations caused by tapping, such as for ascertaining the intensity of said vibrations, may facilitate ascertaining the energy by which (or the force or strength with which) a finger, on which device 310 is worn, is tapping.

Further note that analyzing properties of detected vibrations, such as detected by detection mechanism 312 may facilitate filtering noise from the environment, such as for disregarding vibrations which did not originate from tapping or detaching of a finger wearing device 310.

In some embodiments, vibrations detection mechanism 312 can detect, or facilitate detecting, vibrations which are caused or produced by actions or physical interactions of a finger wearing device 310 other than tapping and detaching. This may be facilitated because different actions and physical interactions of a finger cause (or result in) vibrations having different properties, so that identifying said properties may facilitate ascertaining what action or physical interaction a finger may be performing. For example, vibrations detection mechanism 312 may detect scratching of a surface with a fingernail of a finger on which device 310 is worn. For another example, the detection mechanism may detect vibrations caused by sliding (i.e. moving while in contact) of said finger on a surface.

Following the above, in some embodiments, vibrations detection mechanism 312 of device 310 can facilitate registering input which corresponds to, or are based on, any vibrations caused by any physical interaction of a finger wearing device 310 with any object or surface, such as vibrations caused by any of said finger tapping on a surface, detaching from a surface, scratching a surface and sliding on a surface. Additionally or alternatively, said input may correspond to (or are based on) properties of any physical interaction, such as duration, speed, strength and the like, of which vibrations (or specifically properties thereof) which are caused by that physical interaction may be indicative, and so may be detected for ascertaining said properties. For example, input may be based on vibrations caused by rapid scratching of a surface by a finger (or specifically the fingernail thereof), in a back and forth motion, by detecting said vibrations and analyzing said vibrations for identifying specific properties thereof. For another example, input which corresponds to the energy by which (or the force or strength with which) a finger taps on a surface may be registered by detecting vibrations caused by tapping of said finger on said surface.

Referring now to FIG. 3B, there is shown a system 300 of the invention which includes finger-worn device 310 (see ref. FIG. 3A) and a device 320 with which device 310 can communicate. The finger-worn device is shown in FIG. 3B worn on finger 112 of hand 110.

In some embodiments, the location the tip of finger 112 may be estimated (or detected to a certain degree of precision) by detecting the location of finger-worn device 310, such as by location detection mechanism 222 of the finger-worn device. The location of the tip may be estimated because the location of the finger-worn device corresponds to the location of finger 112 which is wearing the finger-worn device, and because the finger-worn device is worn within a certain distance from the tip of finger 112, said distance depending on the length of finger 112 and optionally depending on bending of the finger (see e.g. international patent application PCT/IB2009/054127 or WO/2009/024971 for deducing or estimating the general location of a finger wearing a finger-worn device, or specifically the general location of the tip of said finger).

In other embodiments, location detection mechanism 222 may be excluded from finger-worn device 310, whereas the location of the tip of finger 112 may be detected by operations of device 320, or specifically by any number of elements thereof. For example, device 320 may include a touch detection mechanism 322 which can detect, or facilitate detecting, the location of touch, such as known for touch-screens detecting the location of touch along a screen.

In some embodiments, device 320 may include a program 328 which can be controlled or influenced by the location of device 310, and/or by the location (or an estimation thereof) of the tip of finger 112, and/or by manipulations of control mechanism 106 of finger-worn device 310, and/or vibrations in finger 112.

In some embodiments, device 320 may include, or be coupled or connected to, a display 324, such as to a liquid-crystal display (LCD) or a so-called “pico-projector”. Optionally, visuals displayed by display 324 may be controlled or influenced, or may react to, the location the tip of finger 112 (or an estimation thereof), and/or to manipulations of control mechanism 106, and/or vibrations of finger 112, such as in case said visuals are included in an interface of program 328. For example, as shown in FIG. 3B, visuals 326, which may be graphics of an interface (e.g. a graphic user-interface) of program 328, may be displayed by display 324 on a surface 324a of the display, specifically when finger 112 taps on the surface and at (or near, within a certain range of distance) a location where the tip of the finger taps on the surface. The displaying of the visuals at (or near) said location, may be facilitated by detecting the location of finger-worn device 310 (e.g. by location detection mechanism 222 of the finger-worn device) and estimating the location of the tip of finger 112 based on the location of the finger-worn device, or alternatively by touch detection mechanism 322 of device 320 detecting touch of the tip of finger 112 where the tip taps. Displaying of visuals 326 when the finger taps on the surface may be facilitated by detecting vibrations, which are caused by the tapping of the tip, by vibrations detection mechanism 312 of the finger-worn device, or alternatively by touch detection mechanism 322 of device 320 facilitating detection of when the tip of finger 112 touches surface 324a, because the tip touches the surface when tapping. Similarly, visuals 326 may disappear when the tip of finger 112 is detached from the surface. Further similarly, any number of properties (e.g. color) of visuals 326, or the state of visuals 326, may be controlled or influenced by manipulating control mechanism 106 of device 310. Further similarly, any number of properties (e.g. size) of visuals 326, or state of visuals 326, may be controlled or influenced by the energy by which (or the force or strength with which) the tip of finger 112 taps on surface 324a (or the force of impact between the tip and the surface) as facilitated by vibrations detection mechanism 312 detecting vibrations caused by tapping of the finger, and by identifying the intensity thereof.

Note that the described above for visuals 326 may refer to any interface element, whereas the described for displaying (of the visuals) may refer to any operation of an interface, program and/or device.

Following the above, a user may interact with device 320 (e.g. control or influence program 328, and/or any interface thereof) by moving finger 112 (and/or hand 110), and/or by tapping with the tip of the finger (not necessarily on any section of device 320), and/or by manipulating control mechanism 106 of finger-worn device 310. Any of said moving, tapping and manipulating may be detected and registered as input from the purpose of interaction with device 320.

Following the above, in embodiments wherein the location of the tip of finger 112 is estimated by detecting the location of finger-worn device 310, interactions with device 320 may be similar to interactions with touch sensing devices known in the art, such as touchpads and touch-screens.

In embodiments wherein the location of the tip of finger 112 is detected by device 320 (e.g. by touch detection mechanism 322), such as in case device 320 is a touch-screen device, detecting vibrations caused by tapping performed by the tip by vibrations detection mechanism 312 of finger-worn device 310, for identifying the intensity of said vibrations and/or for ascertaining the energy by which (or the force or strength with which) finger 112 taps, may provide additional features to interactions with device 320, or with any system which includes a touch-screen. (or a touch-screen device) and finger-worn device 310. For example, touch of the tip of finger 112 tapping of surface 324a of display 324 may be detected by touch detection mechanism 322 of device 320 for registering a corresponding first input, whereas the energy by which (or the force or strength with which) the tip of finger 112 taps may be ascertained by detecting vibrations caused by the tapping by vibrations detection mechanism 312 of finger-worn device 310 for registering a corresponding second input, so that program 328 of device 320 may execute an operation which is based on both said first input and second input.

Following the above, within the scope of the invention are methods for providing additional input to touch input (i.e. input which corresponds to detection of touch), said additional input may correspond to vibrations in a finger which are caused by said finger performing touch, whereas said touch input may correspond to (or derived from) the detection of said touch. Some such methods may include any of the steps of detecting touch of a finger, detecting vibrations caused by said touch, analyzing said vibrations, identifying any number of properties of said vibrations, ascertaining the amount of energy by which (or the force or strength with which) said finger performs touch (e.g. as by a tapping action), registering inputs corresponding to the amount of energy and to touch, and inducing (or executing) operations corresponding to the amount of energy and to touch of said finger.

In some embodiments, and in some cases, vibrations may be caused in finger 112 when it is not desired to register input, such as a user wearing the device does not wish to interact with device 320, or such as when hand 110 is performing tasks not related to interaction. In such cases it may be programmed, designed or set, such as in program 328 of device 320, that operations which correspond to vibrations detected by vibrations detection mechanism 312 will be executed only when control mechanism 106 of finger-worn device 310 is manipulated in a certain manner, or only when finger 112 is within a certain range of (or proximity to) device 320, The latter may facilitate avoiding execution of undesired operations when finger 112 is sufficiently distanced (i.e. being outside of a predetermined range) from device 320.

Referring now to FIG. 3C, there is shown an embodiment of the invention as a finger-worn device 330 (or simply “device”) which can be worn on a finger. Device 330 includes vibrations detection mechanism 332 which can detect, or facilitate detecting, vibrations in (or of) the device. Said vibrations may be caused by a finger physically interacting with the device, such as tapping on a section of the device or sliding on a surface of the device (see e.g. surfaces 346a,b in FIG. 3D). For example, an external surface of device 330, such as in an outer section thereof, may be rugged so that when the tip of a thumb slides on it, friction between said external surface and the tip of said thumb may cause vibrations to be generated which can be sensed by sensors which may be included and/or utilized by vibrations detection mechanism 332. For another example, the device may include a metal section, such that by tapping on the device, said metal section vibrates at a certain frequency.

Note that it is made clear that different types of vibrations, or vibrations having different properties, may be caused by physically interacting with device 330 in different manners, for registering different inputs and/or for inducing different operations. For example, tapping on device 330 may cause a first type of vibrations to be detected by vibrations detection mechanism 332, whereas sliding a finger on a surface of the device may cause a second type of vibrations to be detected by the vibrations detection mechanism. Detection of said first type and second type of vibrations may induce registration of a first input and a second input, respectively, such as in a device to which information about said detection may be communicated.

In some embodiments, device 330 may include a control mechanism 336, similarly to the described above for control mechanism 106, which may be coupled or connected to a vibrations generating mechanism 334, such that by manipulating control mechanism 336 of device 330, corresponding vibrations may be generated. Said corresponding vibrations may be characterized by, and/or be indicative of how (or in other words in what manner) the control mechanism is manipulated. Accordingly, vibrations caused by manipulating control mechanism 336, and/or by vibrations generating mechanism 334, may be detected by vibrations detection mechanism 332 of device 330, for ascertaining how (or in other words in what manner) control mechanism 336 is manipulated.

Note that in some embodiments, a finger-worn device of the invention may include both vibrations detection mechanism 332, for specifically sensing vibrations caused by (or originating from) physical interactions of a finger not wearing said finger-worn device with said finger-worn device (see e.g. the described for FIG. 3D), or specifically by manipulations of a control mechanism of said finger-worn device by a finger not wearing the finger-worn device, and vibrations detection mechanism 312 (see ref. FIG. 3A), for specifically sensing vibrations caused by a finger wearing said finger-worn device performing actions (e.g. tapping) or specifically physically interacting with surfaces. In other embodiments, a finger-worn device of the invention may include a single vibrations detection mechanism having functionalities of both vibrations detection mechanism 312 and vibrations detection mechanism 312, and/or a single vibrations detection mechanism which can facilitate what is described to be facilitated by any of vibrations detection mechanism 312 and vibrations detection mechanism 312.

Referring now to FIG. 3D, there is shown an embodiment of the invention as a finger-worn device 340 (or simply “device”) similar to finger-worn device 330 by including vibrations detection mechanism 332. Device 340 is shown in the figure including surfaces 346a,b on an outer side (or outer section), so that when the device is worn on a finger, the surfaces are exposed and preferably accessible for (or to) a thumb of the same hand of said finger.

Similarly to the described for finger-worn device 330 in FIG. 3C, vibrations detection mechanism 332 of finger-worn device 340 can sense physical interaction of a finger with device 340. Specifically, sliding of a finger, such as a thumb, on any of surfaces 346a,b may cause vibrations which can be detected by the vibrations detection mechanism. Optionally, sliding said finger on surface 346a may cause vibrations which are different than vibrations cause by sliding said finger on surface 346b. Accordingly, it may be ascertained on which surface said finger is sliding by identifying properties of detected vibrations. Further accordingly, sliding a finger from one of surfaces 346a,b to another may be ascertained, such as by detecting a sequence of different vibrations caused by sliding on the different surfaces.

Following the above, a configuration of different surfaces may be included in a finger-worn device of the invention, for ascertaining on which of said different surfaces a finger is sliding, and/or for ascertaining the direction/or speed of sliding of said finger, in case sliding is from one surface to another. Similar results may be obtained by a finger-worn device (which includes a vibrations detection mechanism 332) including surface patterns, textures, topography and/or any other tactile features. Said tactile features may be directionally biased.

Referring now to FIG. 3E, there is shown an embodiment of the invention as a finger-worn device 350 (or simply “device”) similar to finger-worn devices shown in and described for FIGS. 3C and 3D. Device 350 is shown including a vibrations detection mechanism 332′ which is similar to vibrations detection mechanism 332. Additionally or alternatively to the described for vibrations detection mechanism 332, vibrations detection mechanism 332′ can detect vibrations from (or which are caused by) a thumb, preferably of a hand of a finger on which device 350 is worn, physically interacting with said finger, such as tapping on said finger, and/or sliding on said finger, specifically on sections of said finger on which device 350 is not worn. In FIG. 3E there is shown device 350 worn on finger 112 of hand 110, whereas thumb 114 of the hand is shown physically interacting with finger 112, specifically with the intermediate phalanx section of the finger. Similarly to the described for FIG. 3D, by detecting vibrations caused by a physical interactions of the thumb with the finger, and optionally by ascertaining properties of said vibrations, it may be ascertained in which manner the thumb physically interacts with the finger, such as in what speed and/or direction the thumb slides on sections of the finger on which device 350 is not worn. This may be facilitated by the fact that the surfaces of both the thumb and the finger, as known for any thumb or finger, include patterns of friction ridges in the skin, which can serve a similar purpose as described for surfaces 346a,b of device 340 (FIG. 3D).

Note that the described above for the intermediate phalanx section of finger 112 may also refer to any other section of the finger, such as joints and such as the distal phalanx section. Further note that different vibrations may be caused by thumb 114 physically interacting with different sections of finger 112. Vibrations from physically interacting with different sections of the finger may have different distances to travel, by propagating and/or being conducted in hand 110, for reaching device 350 for being sensed and/or detected, and so may be altered differently by traveling, having different properties when reaching the device, such as different intensities which may be diminished from being conducted through different distances in finger 112. This may facilitate ascertaining with which section of finger 112 thumb 114 is physically interacting with, and optionally in what manner.

Note that the described for detecting vibrations in device 310 (FIG. 3A), device 330 (FIG. 3C), device 340 (FIG. 3D) and device 350 (FIG. 3E), and the described for any detection of vibrations by vibrations detection mechanisms of devices of the invention, may be facilitated by ultra-sensitive vibrations sensors known in the art (see e.g. U.S. patent application Ser. No. 11/097,059) and state-of-the-art hearing aid technologies, some of which of a size suitable for being included in finger-worn devices.

Referring now to FIG. 3F, there is shown a finger-worn device 330′ of the invention similar to finger-worn device 330 (see ref. FIG. 3E), by including a vibrations detection mechanism 332″ similar to vibrations detection mechanisms 332 and 332′ which are described above. Finger-worn device 330′ is shown in FIG. 3F worn on thumb 114 of hand 110. Vibrations detection mechanism 332″ of the finger-worn device 330′ can detect vibrations from (or which are caused by) thumb 114 physically interacting with any other section of hand 110, or specifically with any finger of the hand, or more specifically with any section of any finger of the hand. Optionally, physically interacting with different sections of hand 110, fingers of the hand and/or sections of fingers of the hand, may cause different vibrations (or similar vibrations which change differently when reaching finger-worn device 330′), so that by detecting vibrations it may be ascertained which of said sections of hand 110, said fingers of the hand and/or said sections of fingers of the hand the thumb is physically interacting with (optionally in addition to ascertaining in what manner the thumb is physically interacting therewith, in accordance with the described herein for physical interactions). This may be facilitated because different sections of hand 110, fingers of the hand and/or sections of fingers of the hand may have different physical features, so that different vibrations may be generated by physically interacting therewith. This may additionally or alternatively be facilitated by the fact that vibrations caused by physical interactions of thumb 114 with any section of hand 110, or with any finger of the hand, or with any section of any finger of the hand, may change in properties (e.g. intensity) by being conducted (or by propagating) through the hand, such as in case the thumb is physically interacting with a section of the palm, and/or through a finger, in case the thumb is physically interacting with said finger or specifically with a section thereof.

In FIG. 3F there are marked by dashed-dotted circles three sections of finger 112 (i.e. the proximal, intermediate and distal phalanges) with which thumb 114 can physically interact. Following the above, physically interacting with each of said three sections may cause different vibrations (or similar vibrations which change differently when reaching finger-worn device 330′), so that a different input may be registered, and/or a different operation may be induced (e.g. in or by a device with which the finger-worn device is communicating), said different input and said different operation corresponding to which of said three sections the thumb is physically interacting with, and optionally to the manner of the physical interaction.

Following the above, by wearing finger-worn device 330, (see ref. FIG. 3E) and/or finger-worn device 330′ (see ref. FIG. 3F), finger 112, and/or any other section of hand 110, may be physically interacted similarly to operating or manipulating remote controls, controllers or any other handheld devices or instruments, for providing similar functionalities and/or features. For example, controllers are known in the field of video games for being held by a hand for comfortable manipulation of input mechanisms by the thumb of said hand. By wearing finger-worn device 330′ on a thumb, a user may physically interact with different sections of an index finger of the same hand similarly to manipulating input mechanisms of handheld devices or instruments (e.g. a video game controller), whereas each phalanx section and/or joint of said index finger may be physically interacted with for a different purpose (e.g. for registering a different input), so that by said thumb physically interacting with each phalanx section and/or join, a different input may be registered and/or a different operation may be induced, such as similarly to inputs registered and/or operations induced from manipulating different controls of handheld devices or instruments (e.g. tapping on the intermediate phalanx section of said index finger may provide similar or identical input to pressing a first button in a controller, whereas tapping on the distal phalanx section of said index finger may provide similar or identical input to pressing a second button in a controller).

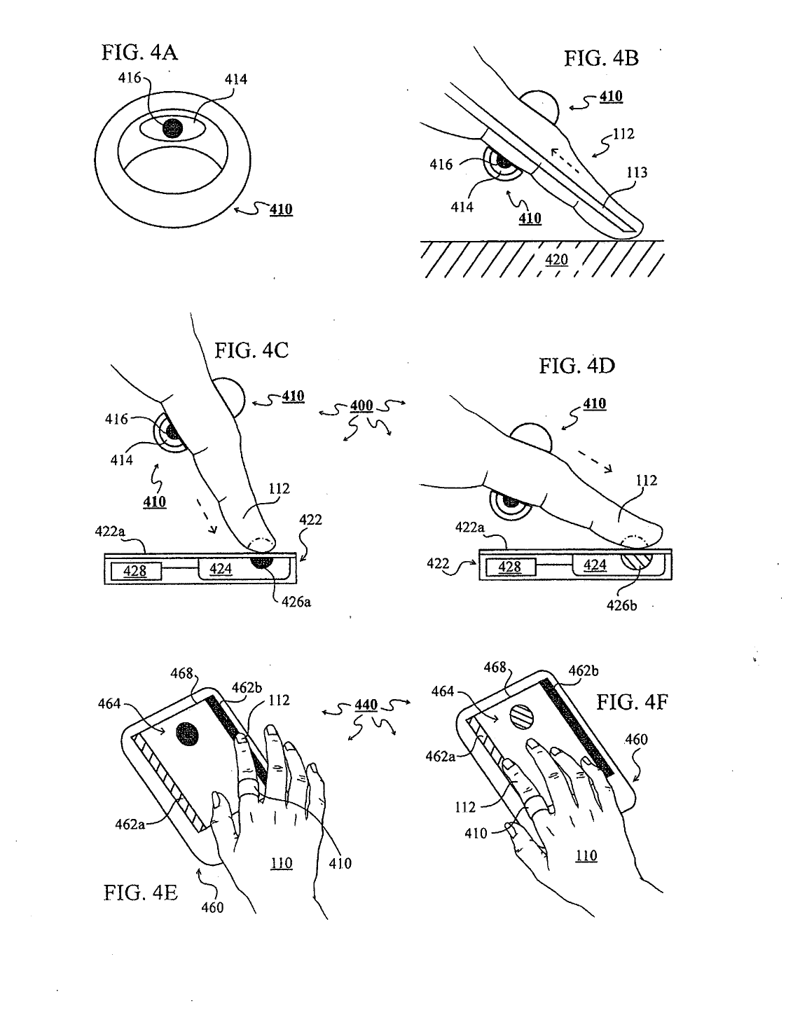

In some embodiments, similar features and/or functionalities of (or which are facilitated by) finger-worn device 330 and/or finger-worn device 330′ specifically ascertaining with which section of a hand, fingers of a hand, and/or sections of a finger of a hand a thumb of the same hand is physically interacting, and optionally in what manner (e.g. whether the thumb is tapping or sliding), may be facilitated by detecting sensations in said thumb and/or in a finger with which the thumb is physically interacting, in accordance with the described below (see ref. FIGS. 4A through 4F) for detection sensations in a finger wearing a finger-worn device, and alternatively to detecting vibrations as described for FIGS. 3E and 3F. This is because similarly to different physical interactions causing different vibrations, and similarly to physical interactions with different sections of a hand and/or finger causing different vibrations and/or vibrations having different properties when reaching a vibrations detection mechanism of a finger-worn device, a thumb physically interacting with different sections of a finger may induce different sensations in said thumb and/or in said finger, said different sensations may be detected in accordance with the described for FIGS. 4A through 4F.

Referring now to FIG. 3G, there is shown an embodiment of the invention as a system 360 which includes a finger-worn device 370 (or simply “device”) which can be worn on a finger, such as on a thumb or an index finger, and an instrument 380.

Instrument 380 is shown including a control mechanism 336′ similar to control mechanism 336 (see ref. FIG. 3C), and a vibrations generating mechanism 334′ similar to vibrations generating mechanism 334 (also see ref. FIG. 3C), whereas control mechanism 336′ and vibrations generating mechanism 334′ may be connected and/or coupled to each other, so that by manipulating the control mechanism, vibrations may be generated by the vibrations generating mechanism.

As shown in FIG. 3G, finger-worn device 370 includes a vibrations detection mechanism 372 similar to the described herein for vibrations detection mechanisms. The finger-worn device may be worn on a finger which manipulates control mechanism 336′ of instrument 380, so that vibrations generated by vibrations generating mechanism 334′ of instrument 380 as a result of manipulating the control mechanism may be conducted through said finger, and detected by vibrations detection mechanism 372 of the finger-worn device. Accordingly, manipulation of control mechanism 336′ of instrument 380 may be ascertained by detection of vibrations which are generated by vibrations generating mechanism 334′ of instrument 380 (in response to the manipulation of the control mechanism). Said detection may be performed by vibrations detection mechanism 372 of finger-worn device 370 which is optionally worn on the finger which manipulates the control mechanism of instrument 380.

In FIG. 3G there is shown finger-worn device 370 worn on thumb 114 of hand 110, whereas instrument 380 is shown held by hand 110. In embodiments in which instrument 380 is a handheld device or a fingers-held device, vibrations generated by vibrations generating mechanism 334′ of instrument 380, when control mechanism 336′ of instrument 380 is manipulated, may be conducted through a finger manipulating the control mechanism (e.g. thumb 114 in the figure), such as in case said vibrations are generated while said finger is manipulating the control mechanism and/or is still in contact with the control mechanism or generally with instrument 380, and additionally or alternatively through hand 110, for reaching vibrations detection mechanism 372 of finger-worn device 370. In such embodiments, finger-worn device 370 may be worn on a finger of hand 110 which is not manipulating the control mechanism, and/or it is not required for a finger manipulating the control mechanism to remain in contact with the control mechanism of instrument 380 and/or with any other section or element of instrument 380, while vibrations are generated, and/or it is not required for vibrations to be generated simultaneously to a finger manipulating the control mechanism.

Note that it is made clear that instrument 380 is not necessarily an electronic device and that generating vibrations by the instrument, or specifically by vibrations generating mechanism 334′ of the instrument, may be by mechanical means.

Referring now to FIGS. 4A and 4B, there is shown an embodiment of the invention as a finger-worn device 410 (or simply “device”) which can be worn on (or by) a finger. In FIG. 4A, device 410 is shown including a sensation detection mechanism 414 which detects, or facilitates detecting, sensations in the tip of a finger wearing the device. In FIG. 4B, device 410 is shown worn on finger 112, whereas the tip of finger 112 is shown touching an object 420. By touching the object, nerve signals (or impulses) which correspond to the sensation of touch in the tip may be conducted from the tip, or specifically from receptors therein, through any of nerves 113 in the finger (e.g. for reaching the central nervous system), and may be sensed or detected by any means known in the art which may be included in and/or utilized by sensation detection mechanism 414, for facilitating detection of sensations in the tip. Note that nerves 113 may refer to “digital” nerves, or to any section thereof.

In some embodiments, sensation detection mechanism 414 may include and/or utilize magnetic fields detection mechanism 416 (or simply “sensing mechanism”) which can sense and/or detect magnetic fields, and optionally properties thereof, generated by conduction of nerve signals (or generally by any nerve impulses), which originate from or caused by sensations in finger 112 (or specifically in the tip thereof), in or through any of nerves 113. Different magnetic fields, or magnetic fields having different properties, may be generated by conduction of different nerve signals which correspond to different sensations of the tip of finger 112, so that accordingly different sensations in the tip of the finger may be detected, such as by sensing said different magnetic fields and detecting (or ascertaining, or identifying) properties thereof.

Because nerve signals are traveling electrical charges (as known for electric currents), and because changes in electric charges create magnetic fields, magnetic fields created by nerve signals can be sensed and/or detected by magnetic fields detection mechanism 416. Because nerve signals pulse or oscillate, changes in said magnetic fields may correspond to, such as characterized by and/or being indicative of, sensations in finger 112 (or specifically in the tip thereof), so that sensing and/or detecting said magnetic fields can facilitate detecting sensations in the finger. Accordingly, for example, magnetic fields detection mechanism 416 may include sensor coils wherein currents may be created by magnetic fields generated by nerve signals passing through any of nerves 113. Said currents may be measured and analyzed (as an exemplary sensing operation) for detecting said magnetic fields and/or for ascertaining (or detecting) which sensations in finger 112 (or specifically in the tip thereof) prompted said nerve signals which generated said magnetic fields which created said currents in said coils. For another example, magnetic fields detection mechanism 416 may be a magnetometer. For yet another example, the sensing mechanism may include solid-state magnetic field sensors or giant magnetoresistance (GMR) sensors.

Creating magnetic fields (or specifically time varying magnetic fields), such as for electromagnetically induced anesthesia (see e.g. U.S. Pat. No. 6,712,753), is known in the art for influencing nerves, such as generating electric currents (or electric fields) in nerves. By an operation opposite to generating electric currents in nerves by creating magnetic fields, magnetic fields generated by electric currents in nerves and may create electric currents in a sensing mechanism of embodiments of the invention (e.g. in a sensing unit of magnetic fields detection mechanism 416 of device 410), whereas the electric currents created in said sensing mechanism may be sensed and/or detected.

Also known in the art are ultra-sensitive magnetic field sensors (see e.g. U.S. Pat. No. 6,712,753) which facilitate including magnetic fields detection mechanism 416 in a device of the invention, specifically in a finger-worn device (e.g. device 410). For example, some eddy-current testing (ECT) sensors (or probes), or specifically spin-valve type giant magnetoresistance (SV-GMR) based ECT probes, are known to be of measurements of few hundred microns for length and width. Additionally, as fingers generally have small amounts of flesh, and “digital” nerves in fingers are generally near the skin, state-of-the-art magnetic field sensing methods and mechanisms, which are suited for providing the results described herein for magnetic fields detection mechanism 416, need not be implanted or inserted into the body, such as known for high-spatial-resolution magnetic-field measurement, for example, and for low-field magnetic sensing.

Note that sensing magnetic fields generated by nerve signals is different from electromyography, wherein electrophysiologic activity is observed in muscle tissue (or specifically muscle fibers), which is lacking in fingers. Furthermore, at rest, muscles are electrically silent, whereas action potentials, which may be measured by electromyographs, may be noticed only when muscles contract. Further still, electromyography relates to motor nerves in so-called “motor units”, or specifically in neuromuscular junction. However, sensing magnetic field by magnetic fields detection mechanism 416 relates to sensory nerves, wherein signals may be conducted in response to sensation and unrelatedly to muscle contraction.

Referring now to FIGS. 4C and 4D, there is shown a system 400 of the invention which includes finger-worn device 410 (shown worn on finger 112) and a device 422 with which device 410 communicates.

In some embodiments, sensation detection mechanism 414 of device 410 can facilitate ascertaining the amount of pressure (or force) applied by a finger (which is wearing the device) on an object or surface, such as by detecting sensations of pressure in said finger (or specifically of the tip thereof), said detecting may optionally be facilitated by sensing nerve signals which are caused by said finger applying pressure and which correspond to the amount of pressure applied. This may be facilitates because by a finger applying pressure on an object or surface, a reaction force, which is proportional to the mount of said pressure, is provided from said object or surface and is applied back on said finger, according to Newton's third law of motion, and so said finger may feel said reaction force (as a sensation) and consequently nerve signals, which may correspond to the amount of force of said reaction force, may be conducted through said finger, and may generate corresponding magnetic fields which may be sensed and detected by magnetic fields detection mechanism 416 of device 410, for ascertaining the amount of the aforementioned pressure applied by said finger.

Following the above, device 410, or specifically sensation detection mechanism 414 of the device, may facilitate detecting pressure (and optionally the amount thereof) applied by a finger, alternatively to the known in the art for fingers pressure sensors. Accordingly, methods of the invention for sensing pressure applied by a finger may include steps of detecting sensations in said finger by and ascertaining the amount of pressure applied by said finger.

In FIGS. 4C and 4D, finger 112 is applying pressure on a surface 422a of device 422 (directions of pressure illustrated by dashed arrows). Following the above, the amount of said pressure may be ascertained (or detected) by sensation detection mechanism 414 detecting corresponding sensations in the finger.

In some embodiments, device 422 may include a program 428 which can be influenced or controlled by finger sensations (i.e. sensations in a finger) and/or detections of finger sensations (e.g. by sensation detection mechanism 414 of device 410), such as in case said detections are registered as inputs in device 422 (e.g. by device 410 communicating relevant information to device 422). Specifically, sensations in (or of) finger 112, or specifically in the tip thereof, and/or detections of said sensations, may control or influence program 428.

In some embodiments, program 428 may include, be coupled to, and/or control, an interface 424 of device 422 with which a user can interact. For example, interface 424 may be a graphic user-interface displayed by device 422 (e.g. by the device including a screen or projector). Similarly to the described above for sensations in finger 112 (or detections thereof) controlling or influencing program 428, interface 424 can react differently to different sensations in finger 112, whereby each of said different sensations corresponds to a different reaction of the interface.

In some embodiments, different operations of program 428 may correspond to, and may optionally be induced by, different amounts of pressure applied by finger 112, as ascertained from detections of sensations in the finger, in accordance with the described above. Similarly, different reactions of interface 424 may be induced (or prompted) by ascertaining different amounts of pressure applied by finger 112. For example, in FIG. 4C finger 112 may be applying a first amount of pressure on surface 422a of device 422, whereas in FIG. 4D the finger may be applying a second amount of pressure on the surface. Consequently, and following the above, an interface element 426a of interface 424 may become activated (FIG. 4C) from (or correspondingly to) ascertaining said first amount of pressure from detecting a corresponding sensation in finger 112 by sensation detection mechanism 414 of device 410, whereas an interface element 426b may become activated (FIG. 4D) from ascertaining said second amount of pressure. Note that any other reactions of interface 424 may be induced correspondingly to said first and second amounts of pressure (and/or correspondingly to the ascertaining or detection thereof), such as setting a different state for an interface element correspondingly to each of the amounts of pressure.

In some embodiments, device 422 may include a touch sensing mechanism, such as a touch-screen or a touchpad, for detecting the location of touch on surface 422a. Following the above, pressure sensing features which are lacking in many common touch sensing technologies may be provided by device 410, or specifically by sensation detection mechanism 414 of the device, or generally by a finger-worn device sensing and/or detecting magnetic fields generated by nerve signals in a finger on which said finger-worn device is worn, and by ascertaining (or detecting) sensations of said finger from computing (or analyzing) detections, and/or any related information, of said magnetic fields.

For example, in some embodiments, the location of touch of finger 112 across surface 422a may be detected by operations of device 422, or any element or mechanism thereof, for registering a first input, whereas the amount of pressure applied by the finger at the location of touch may be ascertained from detected sensations in the finger, for registering a second input, whereas said first and second input may prompt a reaction of interface 424 of device 422, said reaction corresponding to both the aforementioned location of touch and the aforementioned amount of pressure. Said reaction may be similar to reactions known for interfaces of pressure sensing touch-screens. An example of said reaction of interface 424, in case surface 422a is the surface of a touch-screen (which does not include touch sensing functionalities or features) included in device 422, may be displaying an graphic object at the location of touch of finger 112 and setting the size of said graphic object as a size corresponding to the amount of pressure which may have been ascertained from detecting sensations in finger 112.

In some embodiments, the direction (or angle) by which a finger applies pressure on a surface may be ascertained by detecting sensations of said finger. Specifically, in FIGS. 4E and 4F, the direction of pressure applied by finger 112 on surface 422a may be ascertained by detecting corresponding sensations in the finger. This may be facilitated by the fact that different sensations in the finger may be caused by different directions of applying pressure. In FIG. 4C there is depicted a first direction of pressure by a dashed arrow, whereas in FIG. 4D there is depicted a second direction of pressure by a dashed arrow. Similarly to the described for amounts of pressure ascertained by detections of finger sensations, and for program 428 and/or interface 424 of device 422 controlled or influenced thereby, different directions of pressure, and/or detections thereof, may be registered as different corresponding inputs (e.g. a first input for the direction depicted in FIG. 4C and a second input for the direction depicted in FIG. 4D), and/or may induce different operations of program 428, and/or may prompt different reactions of (or in) interface 424.

In some embodiments, device 410 (or specifically the sensations detection mechanism of the device) detecting sensations of a finger on which the device is worn may facilitate ascertaining with which area of the tip of said finger said finger performs touch and/or applied pressure, or in other words which area of the tip of said finger is touching and/or applying pressure. Accordingly, in FIGS. 4C and 4D, sensation detection mechanism 414 may facilitate ascertaining which specific area of the tip of finger 112 is touching and/or applying pressure on surface 422a (or in other words which specific area is touch and/or from which specific area pressure is applied) such as by detecting corresponding sensations of the finger (specifically of the tip thereof). This may be facilitated by the fact that different areas of the tip come in contact with the surface, and optionally feel the reaction force from the surface, when the finger touches with different areas of the tip, and when the finger applies pressure from different areas of the tip. For example, in FIG. 4C there is marked a first area of the tip of finger 112 by a dashed-dotted half-circle, said first area performing touch and/or applying pressure in FIG. 4C, whereas in FIG. 4D there is marked a second area of the tip of finger 112 by a dashed-dotted half-circle, said second area performing touch and/or applying pressure in FIG. 4D, so that following the above, there may be different sensations in finger 112 in each of the figures, said different sensations may be detected by device 410 for ascertaining which of said first and second areas is touching and/or applying pressure in each of the figures.

In some embodiments, ascertaining which specific side of the tip of finger 112 is touching and/or applying pressure on surface 422a may be facilitated by sensation detection mechanism 414 (e.g. utilizing and/or including magnetic fields detection mechanism 416), similarly to the described for specific areas of the tip of finger 112. Said specific side may be any of a left and right sides of the tip perpendicularly to the dorsal and palmar sides (or back and front sides, respectively). For example, in case the hand of finger 112 is a right hand, when facing the palm of the hand, such as in supination, a right side of the finger (and specifically of the tip of the finger) may be the side directed toward the thumb of the hand (in case finger 112 is not the thumb of the hand). For another example, said left and right sides may correspond to the sides where the “digital” nerves of a finger 112 are generally located. Accordingly, ascertaining which specific side of the tip of finger 112, selected from a left and right sides, is touching or applying pressure on a surface (e.g. surface 422a) may be facilitated by separate operations of sensing each of the “digital” nerves, or sensing magnetic fields generated by signals (or impulses) in each of the “digital” nerves, such as by positioning a plurality of sensors in finger-worn device 410 correspondingly to the general location of the “digital” nerves, or in different (e.g. opposite) sides of the finger-worn device.

Similarly to the described for amounts of pressure and directions of pressure ascertained (by detections of sensations) and controlling or influencing program 428 and/or interface 424 of device 422, ascertaining which area and/or side of the tip of finger 112 is touching and/or applying pressure (e.g. on surface 422a) may register an input (or may be registered as input) which is different than ascertaining any other area and/or side of the tip touching and/or applying of pressure, and may induce an operation (e.g. of program 428), such as prompting a reaction of interface 424, said operation different than operations induced by ascertaining touch and/or application of pressure by other areas and/or sides. For example, by applying pressure from the aforementioned first area of the tip of finger 112 (marked in FIG. 4C), a first reaction may be prompted in interface 424 upon registration of input which corresponds to ascertaining that pressure is applied from said first area, whereas by applying pressure from the aforementioned second area (marked in FIG. 4D), a second reaction may be prompted in the interface.

Referring now to FIGS. 4E and 4F, there is shown a system of the invention which includes finger-worn device 410, shown worn on finger 112 of hand 110, and device 460 with which the finger-worn device communicates. Device 460 includes any number of surfaces which provide different tactile sensations upon touch (e.g. touch of a finger). In FIGS. 4E and 4F there is shown the device including surfaces 462a,b, each of which may have different physical features for providing different tactile sensations. Optionally, the surfaces may have constant physical features, such as known for physical textures of different materials, or different topographies of manufactured components. Alternatively, the surfaces may have changing features (or may provide sensations of changing features), such as known in the art for tactile feedback. For example, surface 462a may utilize electrostatic arrays for so-called electrovibration, so that the tactile sensations provided by the surface may change according to electric currents which influence nerve cells differently. For another example, surface 462b may include movable elements which change the topography of the surface, similarly to the known for Braille displays (see e.g. U.S. Pat. No. 5,453,012).

In some embodiments, detecting tactile sensations (in accordance with the described above) provided by any of surfaces 462a,b to a finger when said finger is touching any of the surfaces may facilitate ascertaining which of the surfaces said finger is touching. Similarly to the described above, an input, which corresponds to which of the surfaces said finger is touching, may be registered, for example in device 460, said input may be different from inputs registered from ascertaining said finger touching any other surface. This may similarly refer to inducing different operations, for example of device 460 (or a program and/or interface thereof), by ascertaining said finger touching different surfaces. Accordingly, a user wearing device 410 may interact with device 460 by touching different surfaces of the device, preferably surfaces having different physical features, such as surfaces 462a,b. For example, device 460 may include an interface 464, such as a graphic user-interface displayed on a display 468. By touching surface 462b, as shown in FIG. 4E for finger 112, a first input may be registered, such as by input which corresponds to detection of the sensation in finger 112 when the tip of the finger touches surface 462b, as detected by sensation detection mechanism 414 of device 410 which is worn on the finger. Said first input may prompt interface 464 to react, such as to assume a first state thereof (notice in FIG. 4E a black circle is illustrated for depicting said first state of the interface). Similarly, by touching surface 462a, as shown in FIG. 4F for finger 112, a second input may be registered, such as input which corresponds to detection of the sensation in finger 112 when the finger touches surface 462a, as detected by sensation detection mechanism 414 of device 410 which is worn on the finger. Said second input may prompt interface 464 to react differently, such as to assume a second state thereof (notice in FIG. 4E a circle filled by parallel lines is illustrated for depicting said second state of the interface).

In embodiments of device 460 wherein surfaces of the device (e.g. surfaces 462a,b) can change physical features (or change tactile sensations provided by surfaces of the device for simulating physical feature), when a user is wearing device 410 and interacts with device 460 by touching surfaces thereof, device 460 can set different configurations, settings, conditions, and/or terms for interactions, such as in a program and/or interface, correspondingly to different physical features of said surfaces, or correspondingly to different tactile sensations provided by said surfaces, said different physical features and said different tactile sensation may be set correspondingly to configurations, settings, conditions, and/or terms for interactions. This may be similarly to a touch-screen changing visuals in an interface for providing visual feedback and for changing how a user can interact by touch (e.g. change the locations of interface elements for changing where detection of touch induces certain operations). For example, in such embodiments and in accordance with the described above, touching surface 462a with finger 112 may provide a first tactile sensation in the finger and consequently induce a first reaction of (or in) interface 464 of device 460, whereas touching surface 462b with the finger may provide a second tactile sensation in the finger and consequently induce a second reaction of the interface. Operations of device 460 may then switch the tactile sensations between the surfaces, such as by changing physical features of the surfaces. Then, accordingly, by touching surface 462a, said second tactile sensation may be provided for finger 112 touching the surface, whereas by touching surface 462b, said second tactile sensation may be provided for the finger when the finger touches the surface. Consequently, after switching the tactile sensations between the surfaces (e.g. by controlling actuators which change the topography of both surfaces), touching surface 462a (with finger 112) may induce said second reaction of interface 464, whereas touching surface 462b may induce said first reaction of the interface.

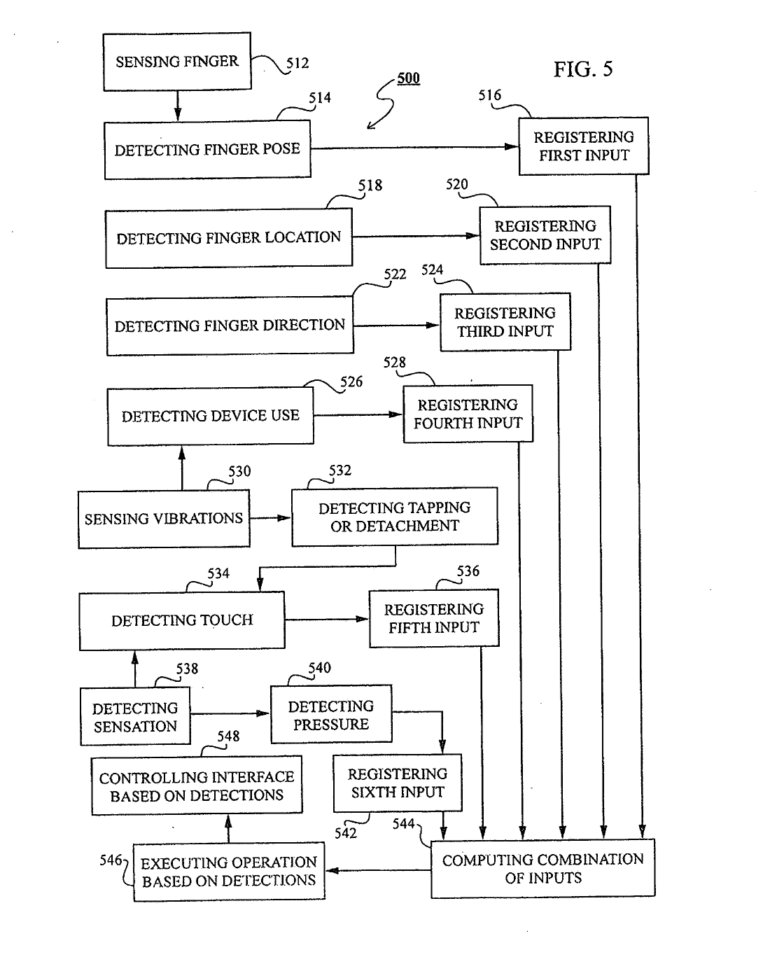

Referring now to FIG. 5, there is shown a flowchart of a method 500 of the invention.

In some methods, the pose of a finger may be detected at a step 514. In other words, detecting whether said finger is bend, and optionally to what extent said finger is bend, may be performed at step 514. Detecting the pose of said finger may be facilitated by any means known in the art (see ref. the described for FIGS. 1A and 1B). For example, a finger bending detection mechanism 104, such as described for finger-worn device 100 in FIG. 1A, may detect bending of a finger on which finger-worn device 100 is worn.

In some methods, detecting the pose of a finger (step 514) may be facilitated by sensing said finger at a step 512. Optionally, sensing at step 512 may specifically be sensing of a section of said finger on which a finger-worn device is worn. For example, an embodiment of finger-worn device 120 (see ref. FIG. 1B) may be worn on the proximal phalanx section of a finger, and may include optical sensing mechanism 124 which can sense the proximal phalanx section of said finger for facilitating detecting the pose (or in other words bending) of said finger at any given time.

In other methods, detecting the pose of a finger (step 514) may be facilitated by electromyography (EMG) mechanism and/or methods, such as by utilizing an electromyograph which may be worn or attached to wrist, forearm or back of palm of a hand of said finger.

In some methods, a first input may be registered at a step 516, from (or in other words as a result of) detecting the pose of a finger (step 514). Said first input may correspond to, or be based on, the pose of said finger, or specifically to any property of the pose (e.g. extent of bending of the finger in the pose). For example, the extent to which a finger is bent, as detected at step 514, may be registered as a first input.

In some methods, the location of a finger may be detected at a step 518. Detecting the location of a finger at step 518 may be facilitated by any means known in the art, such as by touch sensors in case said finger is touching a surface, or such as by optical means.

In some methods, detecting the location of a finger (step 518) may be facilitated by said finger wearing a finger-worn device. A finger-worn device worn on a finger may have a location which is generally the same as said finger, or which is corresponding or in proportion to said finger, to a certain degree of precision. Specifically, a finger-worn device worn on a finger may have a location which is generally the same, for certain purposes, as the section of said finger on which said finger-worn is worn. Accordingly, it is made clear the described for step 518 may refer, in some methods to detecting the location of a section of a finger on which a finger-worn device is worn.

Following the above, in methods wherein detecting the location of a finger, or a section of a finger, is facilitated by wearing a finger-worn device on said finger, or on said section of a finger, said finger-worn device may include any sensing means which facilitate the detection of the location of said finger-worn device (e.g. a location detection mechanism 222; see ref. FIG. 2E), such as motion sensing means (e.g. accelerometers) which facilitate ascertaining (or detecting) the location of said finger-worn device relative to a location wherein the finger-worn device was before a motion was performed. Additionally or alternatively, said finger-worn device may include any indication means for indicating the location of said finger-worn device (e.g. an indication mechanism 224; see ref. FIG. 2E), such as to a remote mechanism which can detect indications from said finger-worn device (e.g. to an indication detection mechanism 228; see ref. FIG. 2E) for analyzing said indications and ascertain (or detect) the location of said finger-worn device.

Note that some methods of the invention may include a step for detecting motion, or specifically relative motion, of a finger, additionally or alternatively to detecting the location of a finger (step 518). Optionally, detecting motion (or specifically relative motion) of a finger may be facilitated in some methods and in some cases by detecting multiple locations of said finger, such as in a certain period of time or along a certain path, from which motion may be ascertained. Oppositely, detecting location of a finger may be facilitated in some methods and in some cases by detecting motion (or specifically relative motion) of said finger.

In some methods, a second input may be registered at a step 520, from (or in other words as a result of) detecting the location of a finger (step 518). Said second input may correspond to, or be based on, the location of said finger (or of a section of said finger on which a finger-worn device is worn).

Note that in other methods, said second input may refer to input registered from (or in other words as a result of), and which preferably correspond to, detecting motion, or specifically relative motion, of a finger, as suggested above for a step of some methods of the invention. Note that in yet other methods, said second input may refer to multiple inputs from, and which preferably correspond to, detecting the location of a finger and detecting motion, or specifically relative motion, of a finger.

In some methods, the direction at which a finger is positioned may be detected at a step 522. Detecting the direction of a finger at step 522 may be facilitated by any means known in the art, such as by utilizing EMG sensors which can facilitate ascertaining gestures of a hand, and specifically the angles of sections of fingers of said hand relative to other sections of said hand.

In some methods, step 522 may refer to detecting the direction of a section of a finger on which a finger-worn device is worn. Because a finger-worn device worn on a section of a finger (e.g. the proximal phalanx section of said finger) is positioned in the same direction, or in a corresponding or proportional direction, for certain purposes, detecting the direction of said finger-worn device may facilitate ascertaining (or detecting) the direction of said section of said finger. In such methods, said finger-worn device may include any means for detecting the direction thereof (e.g. a direction detection mechanism 226; see ref. FIG. 2E) and/or any means for indicating the direction. Note that in some methods, a sensation detection mechanism 414 (see ref. FIGS. 4A through 4D) may serve as means for detecting the direction of a finger (or a section thereof), or may facilitate detecting the direction of a finger, as described for FIGS. 4C and 4D, in case said finger applied pressure on a surface from a certain direction.

In some methods, a third input may be registered at a step 524, from (or in other words as a result of) detecting the direction of a finger, or of a section thereof (step 522). Said third input may correspond to, or be based on, the direction (or angle) of said finger (or of a section of said finger on which a finger-worn device is worn).

Note that the described herein for the direction of a finger, a section thereof and a finger-worn device may refer to a direction or angle relative to any point of reference, such as relative to a surface or relative to the ground.

In some methods, use of a finger-worn device may be detected at a step 526. Use of a finger-worn device may refer to a user operating or manipulating, and/or physically interacting with, any number of elements (e.g. a control mechanism, in accordance with the described herein) or sections (e.g. surfaces having tactile features; see ref. FIG. 3D) thereof. Additionally or alternatively, use of a finger-worn device may refer to a first finger of a user physically interacting with a second finger of said user, any of said first and second fingers may be wearing a finger-worn device which can detect the physical interaction, such as by including a vibrations detection mechanism 332′ or a vibrations detection mechanism 332″ (see ref. FIGS. 3E and 3F, respectively). Further additionally or alternatively, use of a finger-worn device may refer to a finger of a user which is wearing a finger-worn device physically interacting with other devices or objects, such as tapping on a surface (e.g. finger 112 wearing finger-worn device 310 and tapping on a surface 324a; see ref. FIG. 3B) or such as sliding on a surface (e.g. finger 112 wearing finger-worn device 410 and sliding on surfaces 462a,b; see ref. FIGS. 4E and 4F).

In some methods, a fourth input may be registered at a step 528, from (or in other words as a result of) detecting use of a finger-worn device (step 526). Said fourth input may correspond to, or be based on, whether said finger-worn device is used and/or how (in other words in what manner) said finger-worn device is used.

In some methods, vibrations may be sensed at a step 530. Optionally, vibrations sensed at step 530 may originate from, and/or may be caused by, use of a finger-worn device, as described for step 526. Accordingly, in such cases and in some methods, sensing vibrations at step 530 may facilitate detecting use of a finger-worn device at step 526. Further optionally, vibrations sensed at step 530 may originate from, and/or may be caused by, a finger tapping or detaching from a surface (e.g. finger 112 wearing finger-worn device 310 and tapping on a surface 324a; see ref. FIG. 3B). Accordingly, in such cases and in some methods, sensing vibrations at step 520 may facilitate detecting tapping and/or detachment of a finger on or from a surface at a step 532.

Note that in some methods, vibrations may be sensed by a finger-worn device (e.g. device 310; see ref. FIGS. 3A and 3B).

In some methods, touch of a finger, and optionally the location of said touch, may be detected at a step 534. Detecting touch of a finger, and optionally the location of said touch, at step 534, may be facilitated by any means known in the art, such as by a touch-screen or a touchpad.

In some methods, the detection of touch of a finger, and optionally the location of said touch, at step 534, may be facilitated by detecting (or ascertaining) tapping and/or detachment of said finger on or from a surface (step 532), and by ascertaining whether said finger is in contact with a surface, such as by ascertaining whether said finger has tapped on said surface without detaching.

In some methods, a fifth input may be registered at a step 536, from (or in other words as a result of) detecting touch of a finger, and optionally the location of said touch (step 534). Said fifth input may correspond to, or be based on, touch of a finger, and optionally the location of said touch.

Note that in other methods, said fifth input may refer to multiple inputs from, and which preferably correspond to, sensing vibrations (step 530), and/or detecting tapping and/or detachment of a finger (step 532), and/or detecting touch (step 534).

In some methods, sensation of a finger (or in a finger) may be detected at a step 538. Detecting sensation of a finger at step 538 may be facilitated by any means known in art. Optionally, detecting sensation of a finger at step 538 may be facilitated by said finger wearing a finger-worn device, such as finger-worn device 410 (see ref. FIGS. 4A through 4F), which includes means for sensing nerve signals passing through nerves in said finger (e.g. sensation detection mechanism 414, as described for finger-worn device 410).

In some methods, the detection of touch of a finger, and optionally the location of said touch, at step 534, may be facilitated by detecting sensation in (or of) said finger (step 538), such as specifically a sensation of touch in the tip of said finger.

In some methods, pressure applied by a finger may be detected (or ascertained) at a step 540. Detecting pressure applied by a finger may be facilitated by any means known in the art, such as by a pressure sensor, or by a pressure-sensing touch-screen.

In some methods, detecting pressure, and optionally the amount and/or direction thereof, applied by a finger at step 540 may be facilitated by detecting sensation in said finger (step 538), such as by described for ascertaining pressure, and optionally the amount thereof, by sensation detection mechanism 414 of finger-worn device 410 (see ref. FIGS. 4A through 4F). Similarly to the described for ascertaining the amount of pressure applied by a finger by sensation detection mechanism 414 of finger-worn device 410 which is worn by (or on) said finger, some methods of the invention may include a step for ascertaining which specific area of a finger wearing a finger-worn device (preferably areas of the tip of said finger) is applying pressure, said ascertaining may be facilitated by detecting sensations in said finger.

In some methods, a sixth input may be registered at a step 542, from (or in other words as a result of) detecting pressure, and optionally the amount and/or direction thereof, applied by a finger. Said sixth input may correspond to, or be based on, pressure applied by a finger, and optionally to any property of said pressure (e.g. amount and/or direction).

Note that following the above, said sixth input may refer to multiple inputs from, and which preferably correspond to, the amount and/or direction of pressure applied by a finger, and/or which area of said finger is applying said pressure.

In some methods, any of the aforementioned first input (step 516), second input (520), third input (524), fourth input (528), fifth input (536) and sixth input (542) may be computed at a step 544, separately or as a combination. Computing any of the inputs as a combination may refer to utilizing them in (or by) the same program and/or the same function or procedure (e.g. as relevant parameters). Similarly, computing any of the inputs as a combination may similarly refer to utilizing any of the inputs for controlling or influencing the same interface or the same interface element. Additionally or alternatively, computing any of the inputs as a combination may refer to computing any of the inputs correspondingly or contextually to, or in association with, any other. Computing any of the inputs as a combination may similarly refer to any of the inputs setting terms, modes or conditions for computing any other. For example, a function of a program (e.g. a computer application or software) may require a combination of a certain number of the aforementioned inputs for performing computation. For another example, any one of the inputs may set how any of the other inputs is processed (or computed).

Note that following the described for step 544, it is made clear that any number of inputs described herein for any embodiment of a system of the invention, and for any embodiment of a device of the invention, may be computed in that embodiment as a combination, such as for providing or facilitating features or functionalities of that embodiment.

In some methods, an operation based on any detections (see e.g. steps 514, 518, 522, 526, 532, 534, 538 and 540), and/or on any inputs (see e.g. steps 516, 520, 524, 528, 536 and 542), may be executed at a step 546. Said operation may optionally be based on computing any inputs described for the method as a combination, such as described for step 544.

In some methods, an interface, or specifically any number of interface elements, may be controlled or influenced by any detections (see e.g. steps 514, 518, 522, 526, 532, 534, 538 and 540), and/or any inputs (see e.g. steps 516, 520, 524, 528, 536 and 542) at a step 548. Controlling or influencing an interface (or any number of elements thereof) may refer to setting states (or modes), properties, parameters and/or details thereof. Optionally, any number of said detections and/or inputs may control the same interface (or the same interface elements), and/or may set states, properties, parameters and/or details thereof. For example, detections of the direction of a finger, bending of said finger, user of a finger-worn device worn on said finger and the location of said finger at any given time may facilitate selecting the position, state and/or location of an interface element, in accordance with the described for FIGS. 2F through 2J.

Note that the described for a finger in any number of steps of method 500 may refer to the same finger for multiple steps. Further note that the described for a finger-worn device in any number of steps of method 500 may refer to the same finger-worn device for multiple steps.

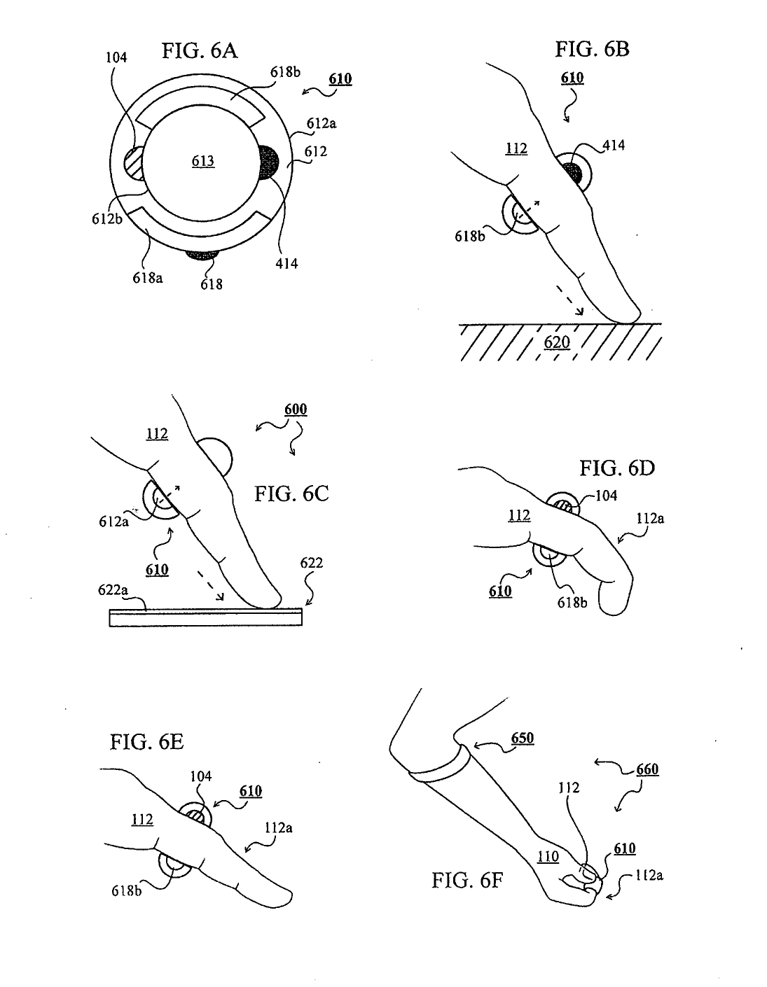

Referring now to FIG. 6A, there is shown an embodiment of the invention as a finger-worn device 610 (or simply “device”) which can be worn on a finger through a cavity 613 of a body 612. The finger-worn device may include any of a tactile sensation mechanism 618a and a tactile sensation mechanism 618b, each of which may provide, or facilitate providing, tactile sensation by any means known in the art.

Tactile sensation mechanism 618b may provide, or facilitate providing, tactile sensation to a finger wearing device 610. For example, the tactile sensation mechanism may be located at an inner section of body 612 of device 610 (i.e. a section of the device which is close to a wearing finger and/or to cavity 613), and/or may be directed toward a finger wearing device 610. For a specific example, a finger may wear device 610 through cavity 613 which is directly surrounded by an inner surface 612b of body 612 of the device, so that inner surface 612b may come in contact with said finger when the device is worn. Accordingly, any number of elements of tactile sensation mechanism 618b may be located on or near surface 612b, or may be directly covered by surface 612b, or may be coupled or connected to surface 612b, or may be directed toward surface 612b, for facilitating providing tactile sensation to said finger by the tactile sensation mechanism.

Similarly, tactile sensation mechanism 618a may provide tactile sensation to a finger physically interacting, or specifically touching, device 610, other than a finger wearing the device. For example, the tactile sensation mechanism may be located at an outer section of body 612 of device 610 (i.e. a section of the device which is exposed when the device is worn on a finger), and/or may be directed away from cavity 613 and/or a wearing finger. For a specific example, a finger not wearing device 610 may touch the device on an outer surface 612a of body 612 of the device, so that said finger comes in contact with surface 612a. Accordingly, any number of elements of tactile sensation mechanism 618a may be located on or near surface 612a, or may be directly covered by surface 612a, or may be directed toward surface 612a, or may be coupled or connected to surface 612a, for facilitating providing tactile sensation to said finger by the tactile sensation mechanism.

In some embodiments, any of tactile sensation mechanisms 618a,b may include and/or utilize any electrotactile or electrovibration means, such as electrotactile or electrovibration stimulators, as known in the art for sensory substitution (see e.g. U.S. Pat. Nos. 6,466,911 and 4926879, and U.S. patent application Ser. No. 12/571,882).

In some embodiments, any of tactile sensation mechanisms 618a,b may include and/or utilize vibrotactile stimulators (see e.g. U.S. Pat. No. 7,561,142) from providing tactile sensations.

In some embodiments, any of tactile sensation mechanisms 618a,b may include and/or utilize mechanical or electromechanical means (e.g. actuators, engines, transducers, springs, cogs and the like) for providing tactile sensations.

In some embodiments, finger-worn device 610 may include finger bending detection mechanism 104, as described above for several finger-worn device of the invention, which can detects, or facilitates detecting, bending of a finger wearing the finger-worn device by any means known in the art.

In some embodiments, finger-worn device 610 may include sensation detection mechanism 414 as described above (see ref. FIGS. 4A and 4B), which can detect, or facilitates detecting, sensation in the tip of a finger wearing the finger-worn device.

In some embodiments, finger-worn device 610 may include a control mechanism 616 similar to control mechanism 106 as described above. Optionally, when a finger manipulates control mechanism 616, tactile sensation is provided to said finger, such as by tactile sensation mechanism 618a. For example, control mechanism 616 may be located on or near outer surface 612a of body 612 of device 610 such that when a finger manipulates the control mechanism, said finger is provided with tactile sensation (e.g. electrotactile sensation) by tactile sensation mechanism 618a. For another example, control mechanism 616 may be connected to or coupled to tactile sensation mechanism 618a such that tactile sensation may be provided directly by a finger contacting the control mechanism, or any element thereof, or any section of device 610 which is coupled or connected to the control mechanism.

Referring now to FIG. 6B, there is shown an embodiment of finger-worn device 610 worn on finger 112 which is shown applying pressure on an object 620 (notice illustrated dashed arrow depicting direction of pressure).

In embodiments of device 610 wherein the device includes sensation detection mechanism 414, in accordance with the described for the sensation detection mechanism, said pressure, and optionally the amount thereof, may be ascertained by detecting the sensation of pressure in finger 112. Similarly ascertained may be the direction of said pressure, and/or which area and/or side of the tip of finger 112 is applying said pressure.

In embodiments of device 610 wherein the device includes tactile sensation mechanisms 618b (see ref. FIG. 6A), tactile sensation may be provided to finger 112 in response to applying pressure on object 620, such as tactile sensation which corresponds to any of the amount of pressure applied, the direction of said pressure and which area or side of the tip of finger 112 is applying said pressure. For example, sensation detection mechanism 414 of some embodiments of device 610 may detect sensations of pressure applied by finger 112 on object 620, so that the amount of said pressure may be ascertained. Consequently, such as by registering said amount of said pressure as input, or utilizing information about said amount in computations, a tactile sensation provided by tactile sensation mechanisms 618b of the same embodiments of device 610 may be modulated correspondingly to said amount, such as in case a large amount may correspond to increasing properties of said tactile sensation (e.g. increasing intensity) and a small amount may correspond to decreasing properties of said tactile sensation (e.g. decreasing intensity).

Referring now to FIG. 6C, there is shown a system 600 of the invention which includes finger-worn device 610 and a device 622 which communicates with the finger-worn device. In FIG. 6C, finger 112 wearing finger-worn device 610 is shown applying pressure on a surface 622a of device 622. Surface 622a may be a pressure sensing surface, as known in the art for pressure sensing surfaces (see e.g. U.S. Pat. No. 6,073,497). Accordingly, surface 622a can sense and facilitate detections pressure applied by finger 112 in FIG. 6C. Further accordingly, in some embodiments of system 600, it is not required for finger-worn device 610 to include sensation detection mechanism 414 for ascertaining pressure applied by finger 112, or any property of said pressure or related information thereto. Accordingly, in some embodiments, sensing pressure by surface 622a may substitute ascertaining pressure from sensation detection, and so tactile sensation may be provided to finger 112 based on, or corresponding to, the amount of pressure the finger applies on surface 622a as sensed by the surface.

Referring now to FIGS. 6D and 6E, there is shown worn on finger 112 an embodiment of finger-worn device 610 including finger bending detection mechanism 104 and tactile sensation mechanism 618b.

In FIG. 6D, finger 112 is shown being in pose 112a. Pose 112a may be ascertained by detecting bending of finger 112 by finger bending detection mechanism 104 of device 610. Consequently, tactile sensation mechanism 618b may provide a tactile sensation which corresponds to pose 112a. For example, pose 112a may be ascertained (or detected) and registered as input which prompts the tactile sensation mechanism to provide a corresponding tactile sensation to finger 112.

In FIG. 6E, finger 112 is shown being in pose 112b. Pose 112b may be ascertained by detecting bending of finger 112 by finger bending detection mechanism 104 of device 610. Consequently, tactile sensation mechanism 618b may provide a tactile sensation which corresponds to pose 112b and which may be different from tactile sensation which corresponds to pose 112a (as described for FIG. 6D). For example, pose 112b may be ascertained (or detected) and registered as input which prompts the tactile sensation mechanism to provide a corresponding tactile sensation to finger 112. Said input may be different from input registered from ascertaining pose 112a.

Referring now to FIG. 6F, there is shown a system 660 of the invention which includes an embodiment of finger-worn device 610 and a fingers poses detection device 650 (or simply “detection device”) which can detect, or facilitate detecting different poses of fingers of a hand (or generally hand gestures) on which the detection device is worn, such as known in the art for electromyography (EMG) devices and phonomyography (PMG) devices. For example, in FIG. 6F, detection device 650 is shown worn on the forearm of hand 110 for facilitating detection of bending of fingers of the hand. Note that the detection device 650 may alternatively be worn on any section of the hand for facilitating detection of poses of fingers.

In FIG. 6F, device 610 is shown worn on finger 112 of hand 110, whereas the finger is shown being in pose 112a. In system 660, it is not required for device 610 to include a finger bending detection mechanism 104, because detection device 650 may be worn on hand 110 to facilitate detection of bending of finger 112 (in accordance with the described for detecting poses of fingers of a hand on which the detection device is worn). Accordingly, pose 112 may be detected (or ascertained) by detection device 650.

Similarly to the described for FIGS. 6D and 6E, in embodiments wherein device 610 includes a tactile sensation mechanism 618b, and in case detection mechanism detects, or facilitates detecting, pose 112a of finger 112, tactile sensation which corresponds to the pose may be provided for finger 112 by the tactile sensation mechanism, whereas other tactile sensations, which correspond to other poses of the finger, may be provided by the tactile sensation mechanism, consequently to detection of said other poses. Note that it is understood that detection device 650 may communicate with device 610, or with a device which communicates with device 610, such as with a computer which analyzes sensing performed by the detection device and remotely controls the tactile sensation mechanism of device 610.

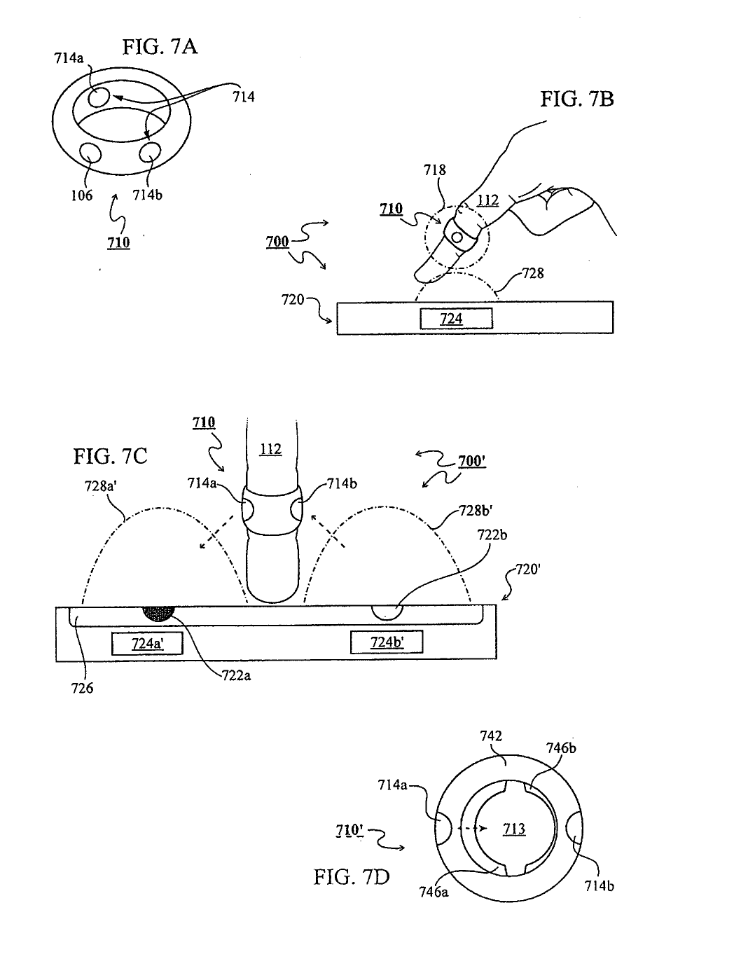

Referring now to FIG. 7A, there is shown an embodiment of the invention as a finger-worn device 710 (or simply “device”) which can be worn on a finger, and which includes a magnetic mechanism 714. Magnetic mechanism 714 may be any mechanism which generates, and/or controls or influences, any number of magnetic fields. For example, the magnetic mechanism may include a current carrying coil, such as a solenoid, the electric current therein may be modulated for controlling properties of a consequently generated magnetic field.

In FIG. 7A, magnetic mechanism 714 is shown including magnets 714a,b which may be (or include) any number of objects which generate and/or influence magnetic fields, such as permanent magnets, or such as electrically changed objects which can move or be moved. For example, magnet 714a may be a current carrying coil which can be mechanically vibrated by an actuator or transducer (e.g. electric motor or piezoelectric actuator) of magnetic mechanism 714, for generating a magnetic field. For another example, magnet 714b may be a permanent magnet.

In some embodiments, finger-worn device 710 may include a control mechanism 106 in accordance with the described above. Optionally, control mechanism 106 (or any number of elements thereof) of device 710 (or any number of sections of the device connected and/or coupled to the control mechanism) may control or influence magnetic mechanism 714 (or operations thereof) of the finger-worn device, such as for setting and/or modulating properties of magnetic fields generated by the magnetic mechanism. In other words, magnetic mechanism 714, or operations thereof, or magnetic fields generated thereby, may correspond to the manner by which control mechanism 106 of device 710 is manipulated. For example, manipulating the control mechanism may cause any number of magnetic fields generated by the magnetic mechanism to change direction, polarity, density, intensity, strength, range, induction and/or any other parameter thereof. For another example, the control mechanism may include a switch, such that by operating said switch, magnetic mechanism 714 may be activated or deactivated. For a similar example, the control mechanism may include a sensor which senses motion, so that when a thumb is moved across said sensor in one direction, magnet 714a may be activated and magnet 714b may be deactivated, whereas when said thumb is moved in an opposite direction, magnet 714b may be activated and magnet 714a may be deactivated.

Referring now to FIG. 7B, there is shown an embodiment of the invention as a system 700 which includes finger-worn device 710, shown worn on finger 112, and a device 720 which may be any electronic device known in the art, such as a desktop computer, a mobile-phone, a car's stereo system and the like.

In FIG. 7B, device 720 is shown including a magnetic mechanism 724 which may be similar to magnetic mechanism 714 of finger-worn device 710. Accordingly, magnetic mechanism 724 may generate, control and/or influence magnetic fields. For example, operations of magnetic mechanism 724 may influence magnetic fields generated by magnetic mechanism 714. For another example, as shown in FIG. 7B, magnetic mechanism 724 may generate a magnetic field 728, whereas magnetic mechanism 714 may generate a magnetic field 718. Any of magnetic fields 718 and 728 may cause device 720 to repel or attract finger-worn device 710, and/or may cause the finger-worn device to repel or attract device 720. Accordingly, in system 700, magnetic mechanism 714 and/or magnetic mechanism 724 may be utilized to produce tactile feedback, for example as known in haptic technology. For example, finger-worn device 710 may be worn on the intermediate phalanx section of finger 112 so that the finger-worn device is generally near the tip of the finger, whereas magnetic field 718 from the finger-worn device and/or magnetic field 728 from device 720 may cause a repulsion between the two devices and consequently between device 720 and the intermediate phalanx section of finger 112. Accordingly, a user which wears the finger-worn device on the intermediate phalanx section of finger 112 may feel said repulsion near the tip of the finger.

The described above may be beneficial in cases where said user is interacting or operating device 720. For example, in some embodiments, device 720 may be a handheld device, whereas finger 112 may be one of the fingers holding device 720. Following the above, magnetic fields generated by device 720, or specifically by magnetic mechanism 724 of the device, and/or magnetic fields generated by finger-worn device 710 (which is worn on finger 112), or specifically by magnetic mechanism 714 of the finger-worn device, may provide tactile (or haptic) feedback to a hand of finger 112, or specifically to hand 112, which said hand is holding device 720. For example, a program of device 720 may generate a magnetic field which creates an attraction between device 720 and finger-worn device 710, such as to notify a user of the finger-worn device about certain information (e.g. an incoming call, in case device 720 is a mobile-phone).

Referring now to FIG. 7C, there is shown a system ‘700’ of the invention, similar to system 700 (see ref. FIG. 7B). System 700′ is shown in FIG. 7C including finger-worn device 710 and a device 720′ similar to device 720 of system 700. Device 720′ may include magnets 724a′ and 724b′ which may be included in a magnetic mechanism of the device. Magnets 724a′ and 724b′ may have, or may generate, magnetic fields 728a′ and 728b′, respectively.

In some embodiments, device 720′ may include a touch sensing mechanism 726 (or simply “mechanism”) which can sense touch, such as known in the art for touch-screens and touchpads. The device may further have an interface (e.g. by including and/or running a program with an interface) which may be interacted with by mechanism 726 sensing touch, such as controlled or influenced by input based on touch sensed by the mechanism. Said interface my include interface elements 722a,b which may optionally be locations where sensing of touch by mechanism 726 registers specific inputs and/or induces specific operations. For example, mechanism 726 may be (or include) a touch-screen displaying a graphic user-interface (GUI), whereas interface elements 722a,b may be visual objects displayed by said touch-screen, so that when a user touches said touch-screen where interface element 722a is displayed, a first operation of device 720′ may be executed, whereas when said user touches where interface element 722b is displayed, a second operation may be executed by the device. For another example, mechanism 726 may be, or include, a touch sensing surface (e.g. a touchpad), whereas a program of device 720′ may define a first set of coordinates as interface element 722a, such as for an interface of said program, and a second set of coordinates as interface element 722b, so that when a finger touches said touch sensing surface at said first set of coordinates, a first input may be registered in the device, whereas when said finger touches at said second set, a second input may be registered.

In some embodiments, as shown in FIG. 7C, magnetic fields 728a′ and 728b′ may be generated at (or near) locations of interface elements 722a and 722b (or corresponding locations), respectively. For example, as shown in the figure, magnet 724a′ may be located directly under (or beneath) interface element 722a. Similarly, also as shown, magnetic field 728b′ may be generated directly above interface element 722b.

In some embodiments, magnetic fields 728a′ and 728b′ may be generated to provide tactile feedback to finger 112 wearing finger-worn device 710, such as when the finger is interacting with device 720′ by touching the device and/or by being positioned within a certain range from the device. Optionally, said tactile feedback may correspond to any of interface elements 722a,b. For example, it may be desired to notify a user of finger 112 that touching device 720′ where interface element 722a is located is preferable to touching the device where interface element 722b is located. Accordingly, magnetic field 728a′ may be a magnetic field which is attractive to magnet 714a of finger-worn device 710, and may be generated where interface element 722a is located (or in close proximity thereto), so that said user feels attraction at finger 112 towards interface elements 722a. Similarly, magnetic field 728b′ may be a magnetic field which is repulsive to magnet 714b of the finger-worn device, and may be generated where interface element 722b is located, so that said user feels a repulsion of finger 112 away from interface elements 722b. Notice that magnets 714a,b may be located at opposite sides of finger-worn device 710, so that attraction from magnetic field 728a′ may be intensified by repulsion from magnetic field 728b′.

Referring now to FIG. 7D, there is shown a finger-worn device 710′ (or simply “device”) similar to finger-worn device 710, such as by including magnets 714a,b as parts of magnetic mechanism 714 (shown in FIG. 7A for finger-worn device 710). Device 710′ may further include tactile sensation generators 746a,b which may be, or include, any means for generating tactile sensation in, or providing tactile feedback to, a finger wearing the device (see e.g. tactile sensation mechanism 618b in FIGS. 6A and 6B).

As opposed to magnetic mechanism 714 in general and magnets 714a,b in particular, tactile sensation generators 746a,b do not require operation of devices other than finger-worn device 710′ (e.g. operations of device 720; see ref. FIG. 7B), or operations of mechanisms not included in the finger-worn device (e.g. magnetic mechanism 724 of device 720), or any external forces or energies (e.g. magnetic force 728), for generating tactile sensation in (or providing tactile feedback to) said finger. For example, tactile sensation generators 746a,b may include actuators which apply mechanical force on finger 112 when the finger is wearing finger-worn device 710′.

In some embodiments, tactile sensation generators 746a,b may generate tactile sensation, or provide tactile feedback, which is directional (or directionally biased). For example, as shown in FIG. 7D, finger 112 may wear finger-worn device 710′ through a cavity 713, whereas tactile sensation generator 746a may be facing the finger when the finger is wearing the device and may press on (or in other words apply pressure to) the finger from a specific direction (notice direction illustrated by a dashed arrow).

In some embodiments, operations of tactile sensation generators 746a,b may correspond to operations of magnetic mechanisms of finger-worn device 710′ and/or of other devices (e.g. magnetic mechanisms 724a,b′ of device 720′; see ref. FIG. 7C). Accordingly, tactile sensation generators 746a,b may be utilized to complement and/or enhance tactile feedback generated (or produced) by magnetic mechanisms. For example, in a system similar to system 700′ (FIG. 7C) wherein finger-worn device 710′ substitutes finger-worn device 710, magnet 724b′ of device 720′ may generate a magnetic field repels device 710′ (or magnets therein), whereas tactile sensation generator 746a may be located correspondingly to the repulsion or to the direction of repulsion of said magnetic field, and may apply pressure to finger 112 (which may be wearing device 710′ for the example) from the same direction as the direction of repulsion of said magnetic field which is repelling finger-worn device 710′. Accordingly, said pressure from tactile sensation generator 742a may complement and enhance said repulsion.

Following the above, within the scope of the invention are methods for providing tactile feedback by creating any of magnetic repulsion and magnetic attraction between a finger-worn device and a touch-screen device with which a finger wearing said finger-worn device interacts. In some methods, said creating may be facilitated by modulating any number of magnetic fields of elements of said finger-worn device and correspondingly modulating any number of magnetic fields of elements of said touch-screen device.

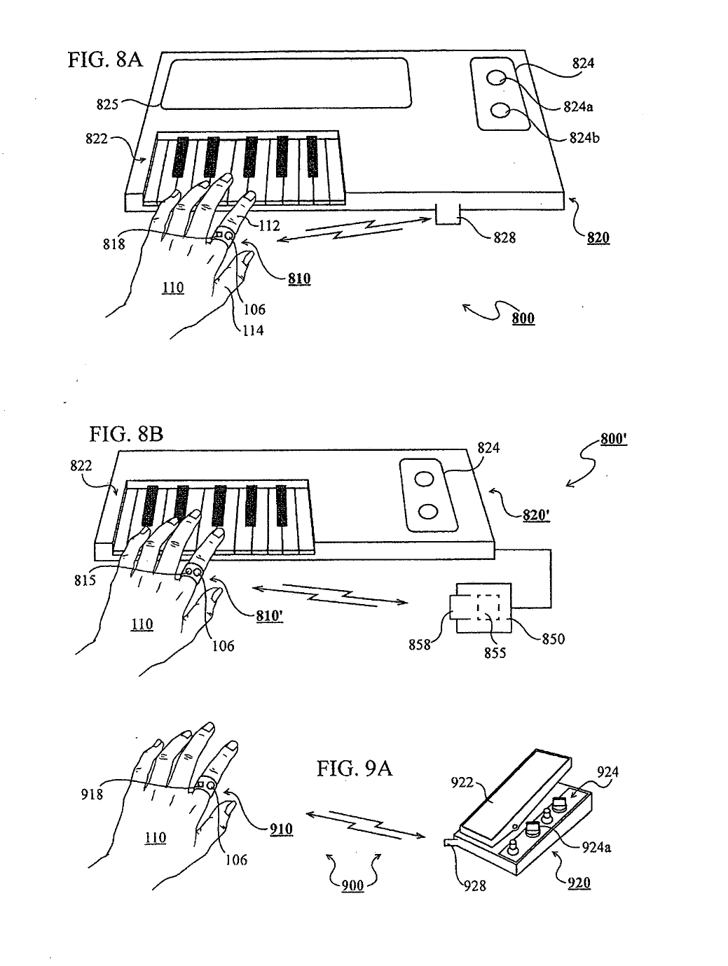

Referring now to FIG. 8A, there is shown an embodiment of the invention as a system 800 which includes a finger-worn device 810 (or simply “device”) and a musical keyboard device 820 (or simply “device” or “keyboard device”). Finger-worn device 810 can be worn on a finger, as shown in FIG. 8A worn on finger 112 of hand 110, whereas keyboard device 820 may be any electronic musical instrument which includes keys 822 which can be manipulated (or operated, or played) to produce music, such as pressed for registering input and/or inducing audio output corresponding to the pressing. For example, keyboard device 820 may be a so-called “electronic keyboard”, “digital keyboard”, “synthesizer” or any peripheral music input device which includes keys and which can be connected to a computer.

In FIG. 8A, finger-worn device 810 is shown including a control mechanism 106 in accordance with the described herein. Optionally, operating the control mechanism may register corresponding input in device 810 and/or in device 820, and/or may induce operations of device 810 and/or device 820.

In some embodiments, device 810 may include a communication mechanism 818 which facilitates communications between the device and any other device or network. In FIG. 8A there is shown keyboard device 820 including a communication mechanism 828 which facilitates communications between the keyboard device and any other device or network. Preferably, any of communication mechanism 828 of keyboard device 820 and communication mechanism 818 of finger-worn device 810 may facilitate communicating information from the keyboard device to the finger-worn device, and/or from the finger-worn device to the keyboard device. For example, communication mechanism 818 may be a transmitter which can transmit signals to communication mechanism 828 which may be a receiver.

In some embodiments, keyboard device 820 may include a control mechanism 824 which can be manipulated (or operated) for registering input and/or for inducing operations. Note that control mechanism 824 may be additional to keys 822 of the keyboard device, and may be operated for registering input which is different from input registered from pressing any of the keys. For example, as shown in FIG. 8A, control mechanism 824 may include a control 824a and a control 824b which can be manipulated by a user for registering input in keyboard device 820.

In some embodiments, operating control mechanism 106 of finger-worn device 810 may be for controlling or influencing output from keyboard device 820, and/or for determining configurations or settings of the keyboard device. Optionally, any element of control mechanism 106 of finger-worn device 810 may be manipulated for similar results as manipulating any element control mechanism 824 of keyboard device 820. In other words, control mechanism 106 may have similar or identical functionality to control mechanism 824 of keyboard device 820. For example, manipulating control mechanism 106 may be for changing the frequency (or influencing the pitch) of a note or tone produced by playing keyboard device 820, similarly to manipulating control 824a of the keyboard device.

Note that in some embodiments, any number of elements of control mechanism 824 of keyboard device 820, which may be known in the art for controlling the output and/or configurations or settings of keyboard devices, may be excluded from keyboard device 820, whereas functionalities of said any number of elements of control mechanism 824 (e.g. controlling output and/or determining configurations or settings of keyboard device 820) may be assumed by elements of control mechanism 106 of finger-worn device 810. In such embodiments, elements of control mechanism 106 of device 810 may be manipulated for registering similar input in device 820 as input registered by manipulating elements of control mechanism 824 of device 820 which are excluded.

Following the above, finger-worn device 810 may serve as a remote control for device 820, optionally assuming, simulating and/or substituting functionalities of any element of control mechanism 824 of device 820. For example, manipulating control 824a may be for adjusting a property of audio output based on playing keys 822 of the keyboard device, such as the frequency of a note or tone, whereas manipulating any element of control mechanism 106 of device 801 may be for adjusting the same property of said audio output.

Note that the described above for elements of control mechanism 106 of device 810 may similarly refer to manners by which the control mechanism is manipulated. For example, manipulating the control mechanism in a first manner may determine a first configuration or settings of device 820, whereas manipulating the control mechanism in a second manner may determine a second configuration of device 820.

The described above (e.g. manipulating control mechanism 106 of finger-worn device 810 for registering similar or identical input as manipulating control mechanism 824 of device 820, such as for inducing similar or identical operations of device 820) may be beneficial when a user uses both hands to play keys 822, so that any of said hands reaching for any element of control mechanism 824 of keyboard device 820 will necessitate that hand being removed from any of the keys, or in other words require any of said hands to stop playing. By a thumb (of a hand of said user wearing finger-worn device 810) manipulating control mechanism 106, only said thumb needs to be utilized, whereas any other finger of the same hand may keep playing without interruption. This may allow for better performance of said user, such as performing so-called “pitch bending” (as known for synthesizer devices) without removing hands from keys 822, or with the same hand which is simultaneously pressing any of the keys.

Following the above, methods of the invention may include steps of simultaneously playing a musical instrument and controlling or influencing settings or configurations of said musical instruments, and/or of output which is based on said playing. Optionally, said controlling or influencing may be performed with the same hand that is playing. There may also be included steps of providing certain functionalities to a musical instrument which lacks said certain functionalities, such as the functionality of controlling or influencing settings or configurations of said musical instrument, by playing said musical instrument while wearing a finger-worn device of the invention.

In some embodiments, in accordance with the described above any element control mechanism 824 of keyboard device 820 which have the same functionality as an element of control mechanism 106 of finger-worn device 810 may be excluded from keyboard device 820, so that keyboard device 820 may be more compact and simple. For example, a system of the invention may include a keyboard device known in the art, from which certain controls are excluded, and a finger-worn device which includes a control mechanism which provide similar or identical functionality as said controls which are excluded from said keyboard device.

In some embodiments, keyboard device 820 may include a display 825 which displayed, or facilitates displaying, visual output, by any means known in the art. Preferably, display 825 may be utilized to display information relevant for a user of keyboard device 820 (and optionally of finger-worn device 810), such as visuals related to operations and/or processes of the keyboard device. For example, display 825 may display certain settings of the keyboard device at any given time, so that a user playing keys 822 may be aware of said settings which may be related to audio output.

Referring now to FIG. 8B, there is shown an embodiment of the invention as a system 800′. System 800′ includes a finger-worn device 810′ similar to finger-worn device 810 and further including a display 815 which displayed, or facilitates displaying, visual output, by any means known in the art, such as a matrix of organic light-emitting diodes (OLED). Note that finger-worn device 810′ may include a communication mechanism 818 (not shown in FIG. 8B; see ref. FIG. 8A). System 800′, as shown in the figure, further includes a musical keyboard device 820′ (or simply “device”) similar to keyboard device 820.

In some embodiments, keyboard device 820′ may include a communication mechanism, such as communication mechanism 828 of device 820 in FIG. 8A. Additionally or alternatively, the keyboard device may be connected to, and/or may communicate with, a computer 850 which may be any device which includes computation means, such as a microcontroller and/or a program.

In some embodiments, computer 850 may include communication mechanism 858 which may facilitate communicating with keyboard 820′ and/or with finger-worn device 810′.

In some embodiments, a connection and/or communication between computer 850 and keyboard device 820′ may facilitate any computations required for any operation of, or related to, keyboard device 820′. For example, computer 850 may process signals from the keyboard device to generate audio output and/or related digital information.

In some embodiments, a connection and/or communication between computer 850 and keyboard device 820′, and communication between the computer and finger-worn device 810′, may facilitate controlling or influencing input and/or output of the computer, the keyboard device and/or the finger-worn device. For example, the finger-worn device may send information to computer 850 for setting how information from the keyboard device is processed by the computer. For another example, communications from the finger-worn device to the computer may prompt the computer to change settings of the keyboard device.

In some embodiments, keyboard device 820′ and/or finger-worn device 810′ may be utilized (e.g. used by a user) to control or influence (or interact with) a program of computer 850, such as a music editing application, and/or control or influence any element or component of the computer, such as a sound-card. Similarly, the keyboard device and/or the finger-worn device may be operated (e.g. control mechanisms of the devices may be manipulated) for registering input in (or by) computer 850. For example, as shown in FIG. 12B, computer 850 may include (and optionally “run”) program 855 which may be, by way of example, musical software, such as an application for recording and/or editing audio information (e.g. sound files), whereas the program may be controlled influenced by operating keyboard device 820′ and/or finger-worn device 810′, such as for changing setting of the program. More specifically, the keyboard device may be “played” (e.g. by pressing on keys 822) for registering input of musical notes in computer 850, whereas the finger-worn device may be operated for registering input of related to certain properties of said musical notes, so the inputs may be utilized (e.g. computed) by program 855 of computer 850 for producing output of musical notes having said certain properties.

In some embodiments, display 815 of finger-worn device 810′ may display any visual output related to operations (or processes) of keyboard device 820′, such as visual indications of information relevant to a user playing keyboard device 820′. Note that this feature may facilitate keyboard device 820′ not having a display. For example, a light of a certain color may be emitted from display 815 for indicating a state of keyboard device 820′ (said certain color preferably corresponding to said state), whereas by emitting other colors, display 815 may indicate other states of the keyboard device. This may facilitate excluding a display from keyboard device 820′, and may facilitate providing visual feedback to a user more effectively, as a user's line of sight may be concentrated on his/her hands playing keys 822, where the finger-worn device, which includes display 815, is generally located.

In some embodiments, similarly to the described above, display 815 of finger-worn device 810′ may display any visual output related to operations of computer 850, said operations may optionally be related to keyboard device 820′.

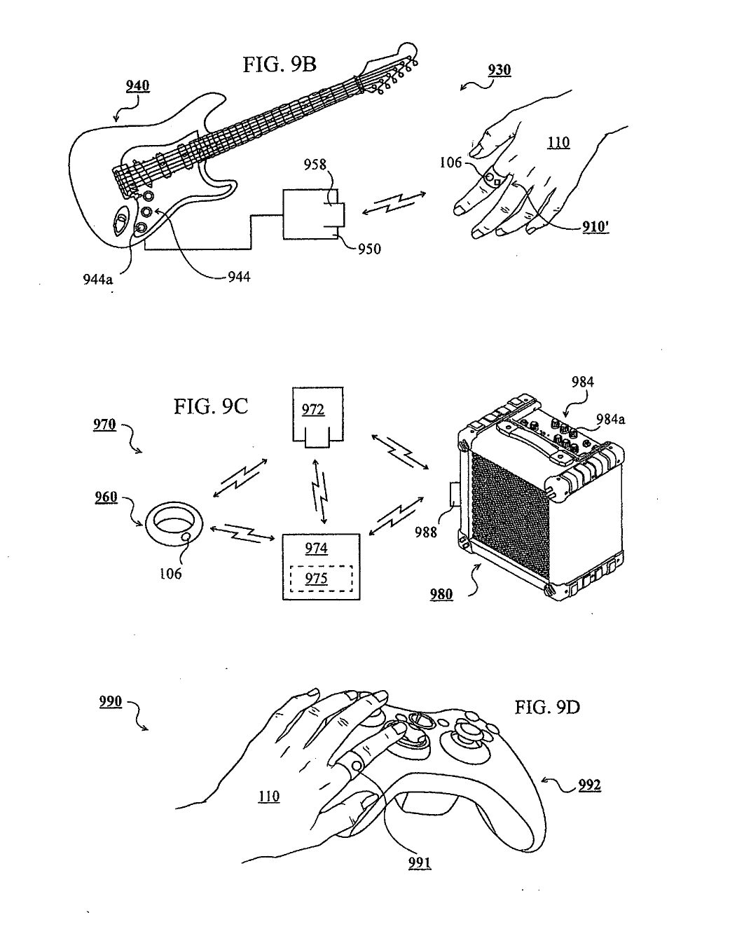

Referring now to FIG. 9A, there is shown an embodiment of the invention as a system 900. System 900 includes a finger-worn device 910 (or simply “device”), which can be worn on a finger), and a musical accessory 920 as known in the art for accessories to musical instruments, such as effects units. Musical accessory 920 is exemplarily shown in FIG. 2A including a pedal unit 922 for a foot of a user to apply pressure thereupon, as known for some effects units, such as known for “wah wah pedals”.

In some embodiments, similarly to the described for finger-worn device 810, finger-worn device 910 may include control mechanism 106 and a communication mechanism 918.

In some embodiments, musical accessory 920 may include a communication mechanism 928 and a control mechanism 924 which can be manipulated to control or influence configurations or settings of musical accessory 920, and/or of any music instrument to which the musical accessory is coupled. For example, manipulating control mechanism 924 of musical accessory 920 may adjust a property (e.g. amount) of distortion which is applied to audio output of (or related to) a musical instrument which is connected and/or coupled to the musical accessory. In FIG. 9A, by way of example, control mechanism 924 is shown including a control 924a.

Similarly to the described for FIGS. 8A and 8B (showing systems 800 and 800′, respectively), in some embodiments, finger-worn device 910 may communicate with musical accessory 920. More specifically, control mechanism 106 of finger-worn device 910 may be manipulated for registering similar (or identical) input, and/or for inducing similar (or identical) operations as manipulating control mechanism 924 of musical accessory 920. For example, manipulating control mechanism 106 in a certain manner may be for changing a specific configuration or setting of musical accessory 920, similarly to operating control 924a or pedal unit 922. Accordingly, and similarly to the described for FIG. 8B, any element of control mechanism 924 having similar (or identical) functionality to any element of control mechanism 106 of finger-worn device 910 may be excluded from musical accessory 920 in some embodiments of system 900.

Referring now to FIG. 9B, there is shown an embodiment of the invention as a system 930. System 930 includes a finger-worn device 910′ similar to finger-worn device 910 (see ref. FIG. 9A). As shown in FIG. 9B, System 930 further includes an electric guitar 940.

In some embodiments, electric guitar 940 may include a communication mechanism 958, similar to the described above for communication mechanisms, for communicating with other devices, such as with a computer 950 and/or with finger-worn device 910′. Note that in some embodiments, the electric guitar may be connected to the computer (in addition to communicating therewith), such as by a cable.

In some embodiments, electric guitar 940 may include control mechanism 944 which can be manipulated for controlling or influencing output and/or configurations (or settings) of the electric guitar. For example, control mechanism 944 may include tone control knob 944a, as known in the art for adjusting the output from in electric guitars, such that the tone of the eventual audible output (e.g. from a speaker or instrument amplifier) may be controlled by such knobs. For another example, control mechanism 944 may include a so-called “whammy bar”, as known for electric guitars. For yet another example, control mechanism 944 may include an operable component (e.g. a button, a switch or the like) which may be operated to control the sensitivity of sensing the strings of electric guitar 940, or which may be operated to provide an effect of shortening the strings, such as achieved with a “capo” (or “capotasto”) guitar accessory, and with a “slide guitar” (or “bottleneck guitar”), and which may be achieved by mechanical or electronic changes in configurations or settings of an electric guitar, such as by a mechanism for shortening the strings, or by a process of adjusting information generated by sensing the strings.

In some embodiments, control mechanism 106 of finger-worn device 910′ may be manipulated for controlling and/or influencing output of electric guitar 940, and/or configurations or settings of the electric guitar. For example, control mechanism 106 may have similar functionality as a whammy bar of electric guitar 940 (which may or may not actually include a whammy bar), so that manipulating control mechanism 106 may be for similar results as operating a whammy bar of an electric guitar. For similar examples, control mechanism 106 of finger-worn device 910′ may have similar functionality as a “slide guitar” accessory or a “capo” accessory.

Following the above, in some embodiments, control mechanism 106 of finger-worn device 910′ may be manipulated for similar results as manipulating any control mechanism 944 of electric guitar 940. For example, operating control mechanism 106 (e.g. rotating a rotatable section of finger-worn device 910′ for registering input) may influence the tone of the sound of electric guitar 940 as outputted by a speaker connected to the electric guitar, whereas a similar influence may be obtained by operating knob 944a of control mechanism 944 of the electric guitar.

Note that in accordance with the described for systems of the invention including musical keyboard devices (FIGS. 8A and 8B) or musical accessories (FIG. 9A), in some embodiments of system 930, any element which may be known in the art for controlling or influencing output and/or configurations (or settings) of electric guitars may be excluded from electric guitar 940, whereas similar controlling or influencing functionalities may be assumed by any element of control mechanism 106 of finger-worn device 910′.

Further note that whereas the described for systems 800 and 800′ (FIGS. 8A and 8B) is for a keyboard device, and whereas the described for system 930 (FIG. 9B) is for an electric guitar, and whereas the described for system 900 is for a musical accessory, similar systems, which may include any other musical instruments, devices and/or accessories, optionally electronic, may be included in the scope of the invention. Accordingly, the described for systems 800, 800′, 900 and 930 may also refer to musical instruments, devices and/or accessories other than keyboard devices 820, 820′, musical accessory 920 and electric guitar 940. Further accordingly, in some embodiments of systems of the invention, a finger-worn device and a certain musical instrument may be included, such that operating said finger-worn device (e.g. manipulating elements of a control mechanism thereof) may be for controlling or influencing output and/or determining configurations or settings of said certain musical instrument. For example, a so-called “DJ controller” or “DJ mixer” is known in the art for mixing audio and being operated by “disc jockeys”. Such electronic musical devices, which produce or control audio output, are known to include several controls, such as knobs, buttons, switches, keys, handles and the like. Following the above, a system of the invention may include a finger-worn device and a “DJ controller” or “DJ mixer”, wherein operating said finger-worn device may result in similar (or identical) operations of said “DJ controller” or “DJ mixer” as operating any of the controls of said “DJ controller” or “DJ mixer”. Further following the above, a system of the invention may include a finger-worn device and a “DJ controller” or “DJ mixer”, wherein certain configurations or settings of said “DJ controller” or “DJ mixer” may be determined only by operating said finger-worn device, and/or certain operations of said “DJ controller” or “DJ mixer” may be prompted only by operating said finger-worn device.

Referring now to FIG. 9C, there is shown an embodiment of the invention as a system 970 which includes any combination of a finger-worn device 960 (which can be worn on a finger), a musical instrument 972 (as known in the art for musical instruments, preferably electric instruments), a computer 974, and an audio output device 980 which can generate or produce any audible output, such as music or sound. For example, audio output device 980 may be (or include) a guitar amplifier.

Note that in some embodiments, any combination of musical instrument 972, computer 974 and audio output device 980 may be a single device having a similar collection of features. For example, musical instrument 972, computer 974 and audio output device 980 may be substituted by system 970 including a mobile-phone (as an exemplary substitution to computer 974) which runs a musical application (as an exemplary substitution to musical instrument 972) and includes speakers which generate audible output (as an exemplary substitution to audio output device 980).

In FIG. 9C, finger-worn device 960 is shown including control mechanism 106 which can be operated or manipulated by a user, similarly to the described herein for controls of finger-worn devices.

In some embodiments, any of finger-worn device 960, musical instrument 972, computer 974 and audio output device 980 may include communication mechanisms (audio output device 980 shown in FIG. 9C, by way of example, including a communication mechanism 988), preferably for communicating with any other of finger-worn device 960, musical instrument 972, computer 974 and audio output device 980. Additionally or alternatively, any of finger-worn device 960, musical instrument 972, computer 974 and audio output device 980 may be connected to any other of finger-worn device 960, musical instrument 972, computer 974 and audio output device 980.

In some embodiments, audio output device 980 may produce or generate audio output which may be correspond to operations of any of finger-worn device 960, musical instrument 972 and computer 974. For example, musical instrument 972 may be operated (or “played”) and may communicate with the audio output device for generating music output which is based on how the musical instrument is operated (e.g. what notes a user “plays” on the musical instrument). Optionally, in a similar example, finger-worn device 960 may be operated for controlling or influencing said music output generated by the audio output device, such as by communicating with the audio output device to setting the frequency of notes in said music output (whereas said notes may be set by operating the musical instrument).

In some embodiments, operations of any of finger-worn device 960 and musical instrument 972 may control or influence computer 974 (or any element thereof), such as by registering input in the computer by communicating therewith. Computer 974 may, in some embodiments, be connected to, and communicating with, audio output device 980, so that the audio output device may generate audio output based on communications with the computer. Optionally, said audio output may be controlled or influenced by finger-worn device 960 and musical instrument 972 controlling or influencing the computer (or any element thereof).

In some embodiments, computer 974 may include (and optionally run) a program 975 which may be, in some embodiments, a program related to audio, sound or music. Optionally, operations of any of finger-worn device 960 and musical instrument 972 may control or influence program 975 of computer 974, such as by providing input for the program. For example, the musical instrument may be connected to, and communicating with, computer 974, whereas the finger-worn device may be wirelessly communicating with the computer, so that inputs may be registered in the computer based on communications of the musical instrument and the finger-worn device with the computer. Said inputs may be utilized (e.g. processed) by program 975 of the computer, such as for recording music which may be generated in the program by computing said inputs. Note that said communications, on which said inputs are based, may be the result of operating the musical instrument and/or the finger-worn device.

In some embodiments, audio output device 980 may include a control mechanism 984 which may be manipulated for controlling or influencing output of the audio output device. For example, control mechanism 984 may include a knob 984a which can be turned to set the volume of sound (as exemplary output) generated by audio output device 980.

In some embodiments, operating finger-worn device 960 (e.g. by manipulating control mechanism 106 of the finger-worn device), may be for controlling or influencing output of audio output device 980. For example, finger-worn device 960 may communicate with audio output device 980, so that when any element of control mechanism 106 of the finger-worn device is operated, communications from the finger-worn device to the audio output device set the volume of sound generated by the audio output device.

In some embodiments, any element of control mechanism 106 of finger-worn device 960 and any element of control mechanism 984 of audio output device 980 may have similar or identical functionality.

In accordance with the described for finger-worn devices, or specifically control mechanisms thereof, having similar or identical functionalities to control mechanisms of other devices, such as specifically to control mechanisms of musical instruments or accessories, and also in accordance with the described for excluding control mechanisms of embodiments of devices, such as in systems wherein a finger-worn device, or any element (e.g. mechanism) thereof, assumes functionalities of the excluded control mechanisms, it is made clear that methods of the invention for providing functionalities to an operable device, such as specifically to a musical instrument, may include a step of assigning functionalities to a finger-worn device, said functionalities may be functionalities of any number of operable means of said operable device.

Referring now to FIG. 9D, there is shown an embodiment of the invention as a system 990 which includes a finger-worn device 991 and a gaming instrument 992 (e.g. a video games controller). The described above for systems of the invention including a finger-worn device and any of a musical instrument, a musical accessory, a computer and an audio output device may similarly refer to embodiments of system 990 wherein the gaming instrument substitutes (for the description) a musical instrument or musical accessory. Additionally, a program related to music, audio or sound may be substituted by a video game or computer game in the described above similarly to substituting an audio output device with a visual (alternatively or additionally to audio) output device, such as a monitor.

In accordance with the described above, in some embodiments of system 990 finger-worn device 991 may provide additional functionalities to gaming instrument 992, such as similarly to the described for finger-worn devices adding functionalities to and/or assuming functionalities of musical instruments or musical accessories, and/or any control mechanisms thereof.

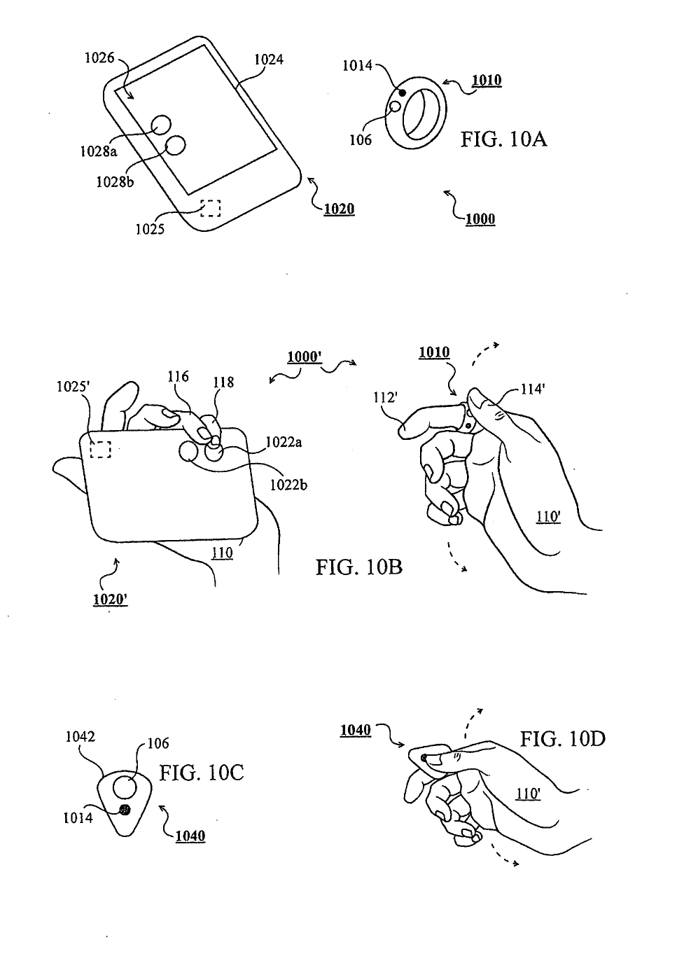

Referring now to FIG. 10A, there is shown an embodiment of the invention as a system 1000. System 1000 is shown including a handheld device 1020, which may be any mobile or portable device which can be held in one hand (e.g. a mobile-phone, a remote control, a gaming controller, a tablet computer and the like), and a finger-worn device 1010 (or simply “device”) which can be worn on a finger. Finger-worn device 1010 may include a control mechanism 106 and a motion sensing mechanism 1014 which can sense, and/or facilitate detecting, motion of the finger-worn device, such as by including an accelerometer. Handheld device 1020 may include a touch-screen 1024 which may be displaying an interface 1026. The interface may be a graphic user-interface (GUI) displayed by the touch-screen, so that a user may interact with the interface by touching the touch-screen. Optionally, interface 1026 may be an interface of a program 1025, or may be coupled to (or with) the program. The program may be included in, and preferably ran by, handheld device 1020.

In some embodiments, interface 1026 may include interface elements 1028a-b. Optionally, the interface elements may be visual objects displayed by touch-screen 1024, and may be interactive, so that by touching the touch-screen where the interface elements are displayed, a user may interact with interface 1026 and/or with program 1025. Alternatively, the interface elements may be locations on touch-screen 1024 where a user may touch to interact with interface 1026 and/or with program 1025. For example, interface element 1028a may include graphic symbols (e.g. “icons”) displayed on touch-screen 1024, so that by touching the touch-screen where the interface element is displayed, a reaction of interface 1026 may be induced. For another example, interface element 1028b may be coordinates which relate to the surface of touch-screen 1024, so that when a user touches the touch-screen at said coordinates, program 1025 may execute a corresponding operation.

In some embodiments, motion of finger-worn device 1010, such as motion caused by moving a finger and/or hand on which the finger-worn device is worn, and preferably as sensed by motion sensing mechanism 1014, may control or influence program 1025 and/or interface 1026, or specifically any of interface elements 1028a-b. Similarly, manipulations of control mechanism 106 of finger-worn device 1010 may control or influence program 1025 and/or interface 1026, or specifically any of interface elements 1028a-b. Optionally, said motion and said manipulation may be combined to control or influence the program and/or the interface. For example, manipulating control mechanism 106 of the finger-worn device may influence or control settings of any of interface elements 1028a-b. Similarly, moving finger-worn device 1010, as sensed by motion sensing mechanism 1014 of the finger-worn device, may influence or control the same or different settings of any of the interface elements.

Referring now to FIG. 10B, there is shown an embodiment of the invention as a system 1000′ similar to system 1000 by including finger-worn device 1010, as described above, and a handheld device 1020′ similar to handheld device 1020 (see ref. FIG. 10A). As opposed to handheld device 1020, handheld device 1020′ does not include a touch-screen. Handheld device 1020′ may include controls 1022a,b which be part of a control mechanism of the handheld device and may be manipulated for registering input and/or inducing operations. As shown in FIG. 10B, handheld device 1020′ may include (and preferably run) a program 1025′. Note that manipulating controls 1022a,b may be for registering input in (or for) program 1025′, or input which may be utilized or computed by the program.

In some embodiments, similarly to the described for system 1000, moving finger-worn device 1010 of system 1000′, and/or manipulating control mechanism 106 (see ref. FIG. 10A) of the finger-worn device, may be for controlling or influencing program 1025′ of handheld device 1020′.

In FIG. 10B, handheld device 1020′ is shown held by hand 110, whereas controls 1022a,b are shown operated by fingers 116 and 118 of the hand. Additionally, finger-worn device 1010 is shown in the figure worn on finger 112′ of hand 110′. The finger-worn device may be operated by thumb 114′ of hand 110′ (e.g. the thumb may be manipulating control mechanism 106 of the finger-worn device) and may be moved by moving finger 112′ and/or hand 110′ (notice dashed-curved arrows depicting optional directions of motion of the finger-worn device, and/or of the finger and/or of the hand).

Referring now to both FIG. 10A and FIG. 10B, and specifically to system 1000 and system 1000′, in some embodiments, input from finger-worn device 1010, specifically from motion of the finger-worn device, and/or manipulation of control mechanism 106 of the finger-worn device, may be computed correspondingly or contextually to, or in association with, input from interacting with handheld device 1020 in system 1000 (FIG. 10A), and with of handheld device 1020′ in system 1000′ (FIG. 10B). Similarly, input from interacting with handheld device 1020 in system 1000 (FIG. 10A), and with of handheld device 1020′ in system 1000′ (FIG. 10B), may be computed correspondingly or contextually to, or in association with, input from finger-worn device 1010. Accordingly, operations may be executed, such as in handheld device 1020′ and/or in handheld device 1020, or in any device communicating with any of the handheld devices, which correspond to interactions with handheld device 1020′ and/or with handheld device 1020, and also which correspond to motion of finger-worn device 1010, as sensed by motion sensing mechanism 1014 and registered as input, and/or to manipulation of control mechanism 106 of the finger-worn device. For example, in system 1000, program 1025 of handheld device 1020 may execute an operation which is based on input from of finger-worn device 1010 (e.g. information about moving of the finger-worn device in a certain manner) and on input from touching touch-screen 1024 of handheld device 1020 where any of interface elements 1028a,b are located. For a more specific example, operations executed by handheld device 1020′ may be influenced by input from both forger-worn device 1010 and from manipulation of any of controls 1022a,b of the handheld device.

Still referring to FIG. 10A and FIG. 10B, and specifically to system 1000 and system 1000′, in some embodiments, program 1025 of handheld device 1020 (FIG. 10A) and program 1025′ of handheld device 1020′ (FIG. 10B) may be any program related to audio, sound or music. For example, input registered by touch-screen 1024 of handheld device 1020 sensing touch, preferably where interface elements 1028a,b are located, may be processed by program 1025 as musical notes, such as for storing sequences of said musical notes and/or for generating corresponding audio as output of handheld device 1020. For another example, input registered by operating controls 1022a,b of handheld device 1020′ may be computed by program 1025′ for generating sounds, such as from speakers of handheld device 1020′ or speakers of any device with which the handheld device communicates. In the same example, following the described for system 1000′, moving finger-worn device 1010 may control or influence said sound, such as in case input from motion of the finger-worn device is computed by program 1025′, optionally in addition to computing input registered by operating the controls of handheld device 1020′.

In some embodiments, interface 1026 may include a visual simulation (or “virtual representation”) of any musical instrument (or section thereof). For example, interface 1026 may include visuals, or specifically graphics, of a fingerboard (or “fretboard”), as known for guitars. For a more specific example, touch-screen 1024 of handheld device 1020 may display, as part of interface 1026, a graphic environment which corresponds to a fingerboard and may be visually similar thereto. Optionally, interface elements 1028a,b may be virtual representations of strings, in said graphic environment, so that when a user touches the touch-screen where said virtual representations are displayed, input, which corresponds to interacting with strings of a guitar, may be registered.

Similarly, in some embodiments, controls 1022a,b of handheld device 1020′ may be positioned similarly to how elements designed to be manipulated by fingers of a user are positioned in any musical instrument. For example, handheld device 1020′ may be designed with a certain similarity to a western concert flute, such as by including an elongated body, whereas controls 1022a,b (of the handheld device) may be positioned on the handheld device similarly to how keys are positioned in common designs of western concert flutes. For another example, controls 1022a,b may be located in handheld device 1020′ in an arrangement which corresponds to locations of strings of a guitar when the handheld device is held similarly to holding a fingerboard when playing a guitar, so that fingers of a user of the handheld device may manipulate the controls similarly to manipulating strings of a guitar (e.g. placing fingers on strings between frets of a fingerboard of a guitar).

In some embodiments, input from interacting with interface 1026 of handheld device 1020 (e.g. by touching touch-screen 1024) and/or input from manipulating any of controls 1022a,b of handheld device 1020′ may be computed (or processed) as audio, sound and/or music, such as notes and/or chords, optionally by program 1025 and/or program 1025′, respectively. For example, by finger 118 of hand 110 manipulating control 1022a of handheld device 1020′, input may be registered which corresponds to a musical note, whereas said musical note may be a musical note which is heard when placing finger at a certain location between two frets of a fingerboard of a guitar.

Following the above, some embodiments of handheld device 1020 and handheld device 1020′ may have an interface simulating a musical instrument, or may be designed similar to a musical instrument, and may optionally be interacted with in a manner similar to playing any known musical instrument.

In some embodiments, operating finger-worn device 1010 may be similar to using a guitar pick when playing a guitar. As shown in FIG. 10B, thumb 114′ of a hand 110′ (which may be a second hand of a user to hand 110 which is shown holding handheld device 1020′) may be placed on the finger-worn device, which may be worn on finger 112′ of hand 110′, similarly to how a hand is holding a guitar pick. Note that by moving hand 110′ similarly to moving a hand holding a guitar pick when playing a guitar (notice curved-dashed arrows illustrating motion directions), the motion of finger-worn device 1010 (which follows the motion of the hand) may be sensed by motion sensing mechanism 1014 of the finger-worn device, and so the motion of the hand may be detected, and corresponding input may be registered. Further note that in some embodiments and in some cases, said input may be registered, and/or computed, only when any specific element of control mechanism 106 of finger-worn device 1010 is manipulated, and/or only when the control mechanism is manipulated in any specific manner, such as to prevent registration and/or computation of said input when the forger-worn device is moving not for the purpose of interaction.

Following the above, operating finger-worn device 1010, preferably similarly to using a guitar pick when playing a guitar, and operating handheld device 1020 (in system 1000) or handheld device 1020′ (in system 1000′), preferably similarly to using a fingerboard when playing a guitar, may simulate playing a guitar, such as for producing audio output similar to audio output produced when playing a guitar, specifically when playing a guitar in a similar manner to operating the finger-worn device and any of the handheld device. Optionally, operating the finger-worn device and any of the handheld devices in a manner similar to playing a guitar (e.g. moving the finger-worn device similarly to moving a guitar pick), may facilitate registering input which corresponds to playing a guitar in a similar manner, and/or may induce operations similar to results of playing a guitar, such as generating audio output which corresponds to operating the finger-worn device and any of the handheld device, and which may also correspond to playing a guitar in a similar manner. For example, touch-screen 1024 of handheld device 1020 may display a “virtual fingerboard” (i.e. a visual and interactive representation of a guitar fingerboard), such as part of interface 1026, so that by holding the handheld device similarly to holding a guitar fingerboard and placing fingers on specific locations of the displayed “virtual fingerboard” (e.g. between frets in said “virtual fingerboard” displayed by touch-screen 1024), a first type of input may be registered (e.g. in handheld device 1020 and/or in a computer communicating with the handheld device), whereas by wearing finger-worn device 1010 on a finger and manipulating control mechanism 106 of the finger-worn device with a thumb of the same hand of said finger, and additionally moving that same hand similarly to moving a guitar pick, a second type of input may be registered. Optionally, said first input may correspond to specific musical notes (and/or chords), in accordance with said specific location of the displayed “virtual fingerboard” on which fingers are placed, whereas said second input may correspond to using a guitar pick across strings of a guitar when playing said guitar, in accordance with the motion of the hand on a finger of which the finger-worn device is worn. Further optionally, and in accordance with the described above, any of said first input and said second input may be computed correspondingly (or contextually) to the other, such as by program 1025′ of the handheld device. Computing any of the inputs correspondingly to the other may be for obtaining information which corresponds to playing a guitar similarly to how the finger-worn device is moved and how touch-screen 1024 is touched, such as for generating audible output (e.g. sound generated by a speaker connected to a computer which communicates with handheld device 1020 and/or with finger-worn device 1010) which corresponds to said playing of a guitar.

In some embodiments, finger-worn device 1010 may be worn on a finger of a hand which is holding handheld device 1020 or handheld device 1020′ for providing motion sensing means (or in other words motion sensing functionality) for handheld device 1020 or handheld device 1020′. When finger-worn device 1010 is worn on a finger of a hand which is holding any of handheld device 1020 or handheld device 1020′, the motion of said hand and of any of the devices is generally the same, for certain purposes. In other words, motion of handheld device 1020 or handheld device 1020′ follows motion of a hand holding any of the handheld devices, similarly to motion of finger-worn device 1010 when worn on a finger of the same hand, and because the finger-worn device may be communicating with any of the handheld devices, motion sensing performed by the finger-worn device, such as specifically by motion sensing mechanism 1014, may be for detecting or ascertaining (and optionally measuring and/or tracking) motion of any of the handheld devices. Accordingly, note that methods of the invention for detecting, and optionally measuring and/or tracking, motion of any handheld device may include a step of wearing a finger-worn device which includes motion sensing means, such as finger-worn device 1010 which includes motion sensing mechanism 1014.

Referring now to FIGS. 10C and 10D, there is shown an embodiment of the invention as fingers-held device 1040 (or simply “device”) which has a body 1042 which can be held by fingers of a hand, such as between an index finger and a thumb.

In some embodiments, fingers-held device 1040 may include a motion sensing mechanism 1014, similarly to the described for finger-worn device 1010 (see ref. FIGS. 10A and 10B). The motion sensing mechanism may facilitate detecting motion of body 1042. The fingers-held device may additionally include a control mechanism 106 which can be manipulated when device 1040 is held.

In some embodiments, body 1042 of fingers-held device 1040 may be shaped (or designed) similarly to a guitar pick, as known in the art.

In some embodiments, device 1040 may be operated similarly to operating finger-worn device 1010 (see ref FIGS. 10A and 10B), such that in accordance with the described for finger-worn device 1010, when used similarly to a guitar pick (e.g. held between an index finger and a thumb and moved similarly to moving a guitar pick when playing a guitar, as shown in FIG. 10D), input may be registered which corresponds to using a guitar pick.

Note that similarly to the described systems 1000 (FIG. 10A) and 1000′ (FIG. 10B) including finger-worn device 1010, within the scope of the invention are similar systems wherein finger-worn device 1010 is substituted by fingers-held device 1040 which may function similarly to the described for the finger-worn device. For example, in a system of the invention which includes fingers-held device 1040 and handheld device 1020, input from device 1040, such as input based on motion of device 1040 as sensed by motion sensing mechanism 1014 of the device, may be computed correspondingly to input from touching touch-screen 1024 of handheld device 1020. For another example, in a similar system of the invention, input from device 1040 may influence how program 1025 of handheld device 1020 computes input which is generated by fingers touching touch-screen 1024 of the handheld device, specifically where interface elements 1028a,b are located.

Further note that any of finger-worn device 1010 (see ref. FIGS. 10A and 10B) and fingers-held device 1040 (FIGS. 10C and 10D) may substitute any of finger-worn devices 810, 810′, 910, 910′ and 960 in any of systems 800, 800′, 900, 900′ and 970 (see ref. FIGS. 8A and 8B, and FIGS. 9A through 9C) such that the described for manipulating control mechanisms of any of finger-worn devices 810, 810′, 910, 910′ and 960 in systems 800, 800′, 900, 900′ and 970 may similarly and additionally refer to moving any of finger-worn device 1010 and fingers-held device 1040, or a hand or finger wearing the finger-worn device, or a hand or fingers holding the fingers-held device. Accordingly, in embodiments of systems 800, 800′, 900, 900′ and 970, wherein finger-worn device 1010 or fingers-held device 1040 is substituting finger-worn devices 810, 810′, 910, 910′ and 960, input may be registered which corresponds to motion of finger-worn device 1010 or fingers-held device 1040, and/or operations may be induced which correspond to motion of finger-worn device 1010 or fingers-held device 1040, in addition to the described for inputs and operations in any of systems 800, 800′, 900, 900′ and 970. Note that input corresponding to motion of finger-worn device 1010 or fingers-held device 1040 may be utilized similarly to the described for input corresponding to manipulations of control mechanisms. For example, input which corresponds to motion of finger-worn device 1010 or fingers-held device 1040 may be computed correspondingly (or contextually) to input from any musical instrument, musical accessory and/or audio output device.

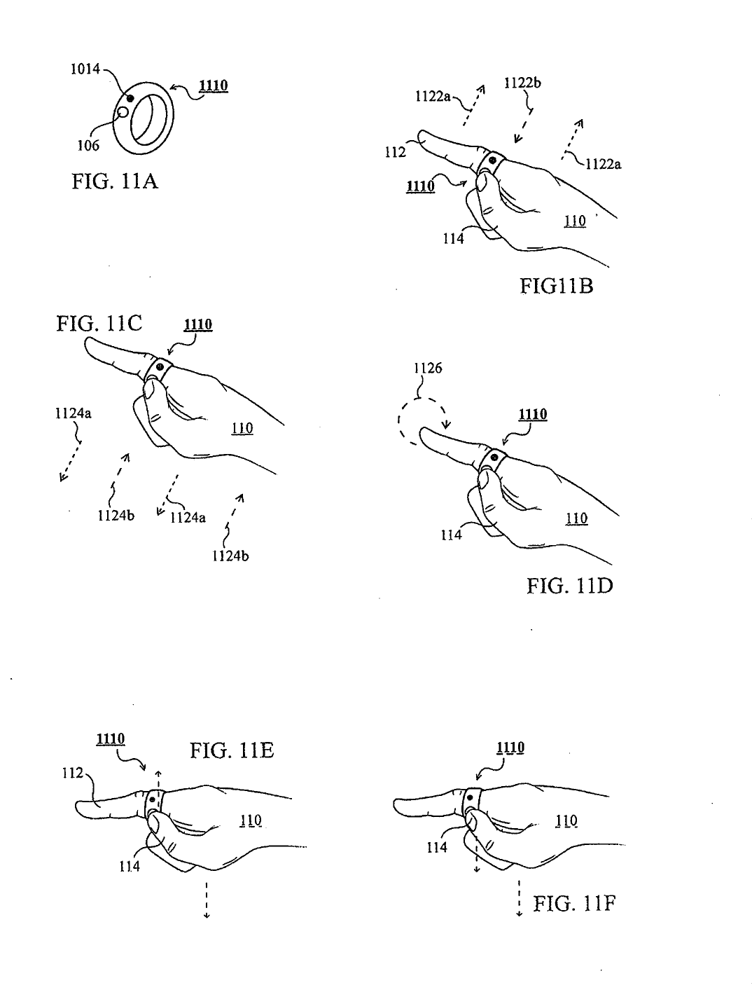

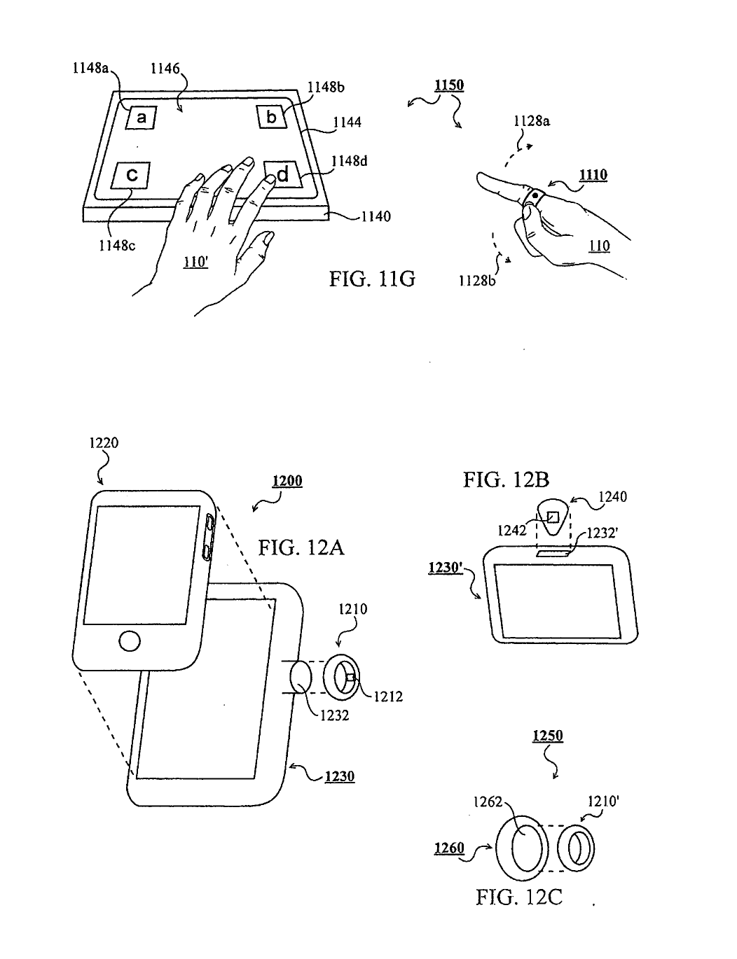

Referring now to FIG. 11A, there is shown a finger-worn device 1110 (or simply “device”) which can be worn on a finger and which includes a motion sensing mechanism 1014, in accordance with the described above. The finger-worn device may further include a control mechanism 106. Accordingly, finger-worn device 1110 may be operated by manipulating the control mechanism and by moving the finger-worn device causing the motion sensing mechanism to sense motion.

Referring now to FIGS. 11B and 11C, there are shown two different sequences of motions (illustrated by dashed arrows) which can be performed by finger 112 and/or hand 110 for registering two different inputs, and/or for inducing two different operations. Registering any of said two different inputs may be facilitated by finger-worn device 1110 which is shown worn on finger 112 and which may sense each of said two different sequences of motions, such as by utilizing motion sensing mechanism 1014. Note that said two different inputs may be registered in (and/or by) finger-worn device 1110, and/or in any device with which the finger-worn device communicates. Further note that said two different operations may be operations of finger-worn device 1110, and/or of any device with which the finger-worn device communicates, and may be operations induced by said two different inputs.

In FIG. 11B, there is shown a sequence of motion 1122a and motion 1122b performed in the following order: motion 1252a followed by motion 1122b, followed by motion 1122a again. Optionally, motion 1122a may be a rapid movement of hand 110 in a certain direction, whereas motion 1122b may be a slow movement (relative to motion 1122a) of the hand in an opposite direction. Following the above, by sensing (preferably by finger-worn device 1110, or specifically by motion sensing mechanism 1014 of the finger-worn device) the sequence of motions 1122a,b in the order shown in and described for FIG. 11B, a first input, which preferably corresponds to the sequence of motions 1122a,b, may be registered, and/or a first operation, which preferably corresponds to the sequence of motions 1122a,b, may be executed.

In FIG. 11C, there is shown a sequence of motions 1124a and 1124b performed in the following order: motion 1124a followed by motion 1124b, followed by motion 1124a again, followed by motion 1124b again. Optionally, motion 1124a may be a movement of hand 110 in a certain manner, whereas motion 1124b may be a movement of the hand in a different manner. Further optionally, after performing the sequence shown in FIG. 11C, hand 110 may be positioned at the same place it was before the sequence was performed. Following the above, by sensing the sequence of motions shown in FIG. 11C (e.g. by motion sensing mechanism 1014 of finger-worn device 1110), a second input may be registered (preferably input corresponding to the sequence of motions shown in FIG. 11C), and/or a second operation may be executed (preferably an operation corresponding to the sequence of motions shown in FIG. 11C).

For example, a user of finger-worn device 1110 may wear the finger-worn device on a finger and move said finger in a sequence of motions 1122a,b as shown in, and described for, FIG. 11B, so a certain input is registered in a device with which the finger-worn device is communicating, said certain input may be different from a different input registered from moving said finger in a sequence of motions 1124a,b as shown in, and described for, FIG. 11C. For another example, hand 110, on a finger of which finger-worn device 1110 is worn, may be moved in motion 1122a, then in motion 1122b, and then in motion 1122a again (for the sequence shown in FIG. 11B), so that a certain operation is executed in a device with which the finger-worn device communicates, whereas the hand may be moved in motion 1124a, then in motion 1124b, then in motion 1124a again and then in motion 1124b again (for the sequence shown in FIG. 11B), so that a different operation is executed in said device with which the finger-worn device communicates.

Referring now to FIG. 11D, there is shown a motion 1126 performed by hand 110, and/or by finger 112 of hand 110, on which finger-worn device 1110 is worn. By way of example, the motion may be a circular movement of the hand and/or finger, as illustrated by a curved dashed arrow in FIG. 11D. Similarly to the described above for FIGS. 11B and 11C, motion 1126 may be sensed by finger-worn device 1110, or specifically by motion sensing mechanism 1014 of the finger-worn device, for registering corresponding input and/or for executing a corresponding operation, in finger-worn device 1110 and/or in any device receiving communications from the finger-worn device. Said corresponding input and corresponding operation may be different than any of the inputs and operations which correspond to sequences of motions shown in, and described for, FIGS. 11B and 11C.

Note that the described herein for inputs corresponding to motions, such as motions of a finger-worn device which includes a motion sensing mechanism, may refer to inputs which correspond to (e.g. include information about) any property of any number of motions, such as to a speed and/or path (or track) of a motion, or such as to the beat or rhythm of a sequence or combination of motions. For example, in some embodiments of system 930 (see ref. FIG. 9B), input may be registered which corresponds to a rhythm by which a user moves hand 100, on which finger-worn device 910′ is worn, said rhythm may be ascertained by the finger-worn device sensing motion of the hand. Note that following the example, the described herein for systems of the invention including musical instruments, or simulating playing musical instruments, may similarly refer to systems (which are included in the scope of the invention) which include music-related games such as known the rhythm games genre.

Referring now to FIGS. 11E and 11F, there are shown two different combinations of motion of hand 110, and/or of finger 112, on which finger-worn device 1110 is worn, and of manipulations of control mechanism 106 of the finger-worn device. Each of said different combinations may be registered as a different input (or a different combination of inputs), and/or may induce a different operation, in (or by) finger-worn device 1110, and/or in (or by) any device with which the finger-worn device communicates.

In FIG. 11E, for a first combination, thumb 114 of hand 110 may manipulate control mechanism 106 of finger-worn device 1110 in a first manner, whereas hand 110 and/or finger 112 may perform a first motion. In FIG. 11F, for a second combination, thumb 114 may manipulate the control mechanism in a second manner, whereas hand 110, and/or finger 112, may perform said first motion. For example, control mechanism 106 may include motion sensors and/or touch sensors which can sense thumb 114 and facilitate detecting of the direction by which the thumb slides on a surface of finger-worn device 1110, whereas motion sensing mechanism 1014 of finger-worn device 1110 may sense the direction of motion of hand 110. Following the directions illustrated in FIGS. 11E and 11F as dashed arrows, said first combination (FIG. 11E) may include a manipulation (by thumb 114) of the control mechanism in a certain direction, and also include hand 110 moving in an opposite direction, whereas said second combination (FIG. 11F) may include a manipulation of the control mechanism in a certain direction, and also hand 110 moving in the same direction.

Note that any combinations of manipulation of control mechanism 106 of finger-worn device 1110 and of motion of a finger and/or hand on which the finger-worn device is worn, such as other than shown in FIGS. 11E and 11F, may register as corresponding input and/or may induce a corresponding operation. For example, control mechanism 106 may facilitate sensing the amount of pressure applied by thumb 114 on a surface of finger-worn device 1110, such as by being coupled to a pressure sensor, so that a combination of thumb 114 applying a certain amount of pressure on said surface and of a finger (on which finger-worn device 1110 is worn) moving in a certain manner, may be registered as input and induce execution of an operation which corresponds to both said certain amount of pressure and to said certain manner.

Note that the described for finger-worn device 1110 in FIGS. 11A through 11F (and for FIG. 11G below) may similarly refer to fingers-held device 1040 (see ref. FIGS. 10C and 10D).

Referring now to FIG. 11G, there is shown an embodiment of the invention as a system 1150 which includes a touch-sensing device 1140, which can be interacted with by touch, and finger-worn device 1110.

As in FIGS. 11A through 11D, the finger-worn device is shown in FIG. 11G worn on a finger of hand 110. Further shown in FIG. 11G is hand 110 performing a motion 1128a and/or a motion 1128b, or any sequence of motions 1128a,b (illustrated as curved dashed arrows in the figure, for depicting paths of movement of the hand). In accordance with the described above, motions of (or performed by) hand 130, and/or of finger 112 (on which finger-worn device 1110 is worn), and/or any sequences thereof, may be sensed by the finger-worn device and registered as corresponding input. Additional input may be registered by control mechanism 106 of finger-worn device 1110 being manipulated.

Note that in some embodiments and in some cases, input from sensing motions of hand 110 by finger-worn device 1110 may be registered only when control mechanism 106 of finger-worn device 1110 are manipulated, or more specifically only when the control mechanism is manipulated in a certain manner.

In system 1150, in addition to the described above, input may be registered by touch-sensing device 1140 sensing touch, such as touch of hand 110′ (which may be the other hand of hand 110 of the same user) as shown in FIG. 11G.

In FIG. 11G, touch-sensing device 1140 is shown, by way of example, including a touch-screen 1144 and an interface 1146. The interface may include interface elements 1148a-d, any of which may be a visual interface element and displayed by the touch-screen. Further shown in the figure is hand 110′ touching touch-screen 1144. By way of example, the hand is shown specifically touching where interface element 1148d is located and/or displayed, so that input may be registered which corresponds to the interface element. Accordingly, following FIG. 11G, a combination of inputs may be registered, any of said input corresponding to interface element 1148d, to manipulating control mechanism 106 of finger-worn device 1110 and to hand 110′ moving in any of motions 1128a,b (or any sequence thereof). Said inputs in said combination may be computed correspondingly to each other, or may control or influence computations of each other, or may induce operations which relate to any thereof.

Referring now to FIG. 12A, there is shown an embodiment, of the invention as a system 1200 which may include a finger-worn device 1210 (or simply “device”) which can be worn on a finger, and a case 1230. Case 1230 may be any case (or “casing”) or cover, such as known for protective case for mobile-phones, or any carrying and/or protective solution for mobile, portable or handheld devices (e.g. so-called “iPhone bumpers” for iPhone devices). For example, case 1230 may be a wallet-case, as known in the art for cases for mobile phones which can also serve as wallets. For another example, case 1230 may be a so-called “sleeve” or “jacket” accessory for portable devices such as certain gaming consoles. For yet another example, case 1230 may be a small bag for tablet devices.

In FIG. 12A, a handheld device 1220, which may be any mobile, portable or handheld device, is shown ready to be inserted into and/or installed inside case 1230. Otherwise, the case may cover, envelop, encase, be mounted on, or be installed on the handheld device. Optionally, the handheld device and the case may be connected. For example, the case may be harnessed to the handheld device. For another example, elements of the handheld device and the case may interlock, such as to secure the handheld device in the case.

In some embodiments, finger-worn device 1210 may be attached or connected to case 1230. This may be beneficial for a finger-worn device which is related to a handheld device with which case 1230 is used, or in other words which case 1230 is the case of (e.g. handheld device 1220, as shown in FIG. 12A). The finger-worn device may then be carried with said handheld device conveniently and securely. Optionally, case 1230 may include a connection unit 1232 which facilitates a connection between the case and finger-worn device 1210, whereas the finger-worn device may include a connection unit 1212 which facilitates a connection between the case and the finger-worn device. For example, case 1230 may include a protruding section (as an exemplary connection unit 1232) on which the finger-worn device may be mounted. For another example, finger-worn device 1210 may include a magnet (as an exemplary connection unit 1212) which may be attached to a magnet of the case, so that an attraction between the magnets secures the finger-worn device in (or on) the case. For yet another example, case 1230 may include a compartment or slot into which finger-worn device 1210 may be inserted.

Referring now to FIG. 12B, there is shown a system similar to system 1200 (see ref. FIG. 12A). In FIG. 12B there is shown a case 1230′ similar to case 1230, and a fingers-held device 1240 similar to fingers-held device 1040 (see ref. FIGS. 10C and 10D). Optionally, case 1230′ may be a case of handheld device 1220 (see ref. FIG. 12A) or of any portable device which can be operated, used or interacted with in combination with operating fingers-held device 1240. Similarly to the described for system 1200, case 1230′ may include a connection unit 1232′, whereas fingers-held device 1240 may include a connection unit 1242, any of which may facilitate a connection between the peripheral device and the case.

Referring now to FIG. 12C, there is shown a system 1250 of the invention which includes a finger-worn device 1210′ similar to finger-worn device 1210, and a case 1260 which may be any protective case or cover for finger-worn device 1210′. For example, case 1260 may be a plastic or metal capsule which can hold the finger-worn device so that the finger-worn device is protected from casual (accidental and incidental) damage from the environment and from becoming dirty. This is particularly beneficial for finger-worn devices which may not be constantly worn on a finger yet worn only when in use and carried when not in use, at which time they may be vulnerable to damage and dirt.

Note that similarly to the described for FIGS. 12A and 12B, any of case 1260 and finger-worn device 1210′ may include a connection unit for facilitating a connection between the case and the finger-worn device.

Note that devices and systems of the invention, as described herein, may include any components and elements necessary for their operation, specifically for features, functionalities, purposes or results described herein. Said components and elements may be expected by any person skilled in the art. For example, several finger-worn devices described herein may require a power-source (e.g. a battery) for supplying power to electric components of such devices, whereas the inclusion of a power-source in the description may be trivial in the field of the invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A method for detecting motion of a handheld device comprising the steps of
a) receiving information derived from a finger-worn device sensing motion, said finger-worn device worn on a finger of a hand holding said handheld device; and
b) analyzing said information for ascertaining motion of said handheld device.

2. A method for detecting bending of a finger comprising the steps of:
a) receiving information derived from a finger-worn device sensing tension in the skin of the proximal phalanx section of said finger on which said finger-worn device is worn; and
b) analyzing said information for ascertaining bending of said finger.

3. The method of claim 2, further comprising the step of comparing tension in areas of the skin located in opposite sides of the proximal phalanx section of said finger.

4. A method for detecting touch of a finger comprising the steps of
a) sensing magnetic fields generated by impulses of nerves in said finger; and
b) analyzing information derived from said sensing for ascertaining whether said finger is performing touch.

5. The method of claim 4, further comprising the step of analyzing information derived from said sensing for ascertaining an amount of pressure applied by said finger against a surface.

6. The method of claim 4, further comprising the step of analyzing information derived from said sensing for ascertaining which side of said finger is performing touch.

7. A finger-worn device comprising means for providing tactile feedback to a finger on which the finger-worn device is worn, wherein said tactile feedback corresponds to pressure applied by said finger.

8. The finger-worn device of claim 7, further comprising means for providing tactile feedback to a finger operating the finger-worn device.

9. A system comprising:
a) a touch-screen; and
b) a finger-worn device,
wherein said finger-worn device detects vibrations caused by touching said touch-screen in a finger wearing said finger-worn device.
